(19) United States
(12) Patent Application Publication
(10) Pub. No.: US 2017/0213303 A1
(43) Pub. Date: Jul. 27, 2017

(54) BUILDING FAULT TRIAGE SYSTEM WITH CROWDSOURCED FEEDBACK FOR FAULT DIAGNOSTICS AND SUGGESTED RESOLUTIONS

(71) Applicant: Johnson Controls Technology Company, Holland, MI (US)

(72) Inventors: Dimitrios S. Papadopoulos, Westwood, NJ (US); Marc V. Perrone, Shorewood, WI (US); Gerald A. Asp, Milwaukee, WI (US); Curtis R. Erickson, Littleton, CO (US)

(73) Assignee: Johnson Controls Technology Company, Holland, MI (US)

(21) Appl. No.: 15/004,785

(22) Filed: Jan. 22, 2016

(51) Int. Cl. G06Q 50/16; G06F 17/30

(52) U.S. Cl. CPC G06Q 50/163; G06F 17/3053; G06F 17/30554; G06Q 10/20

(57) ABSTRACT

A fault resolution system includes a fault triage system, a fault resolutions database, and a user device. The fault triage system generates rankings for a plurality of faults detected in a building system and prioritizes the detected faults according to the rankings. The fault resolutions database stores one or more potential resolutions for each of the detected faults and a success rate for each of the potential resolutions. The user device receives the prioritized faults, the potential resolutions, and the success rates from the fault triage system and provides resolution feedback to the fault triage system indicating whether the potential resolutions were successful in resolving the detected faults. The fault triage system uses the resolution feedback to update the success rates stored in the fault resolutions database.

### BACKGROUND

The present invention relates generally to fault detection and diagnostics for building systems. The present invention relates more particularly to systems and methods for providing recommended solutions to faults detected in a building system.

A building management system (BMS) is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. Some BMSs include the ability to detect and diagnose faults in building equipment. However, conventional fault diagnostics can be time consuming to perform and often fail to isolate the root cause of a detected fault.

Some fault diagnostic systems provide a user with a list of potential reasons why a fault may occur. However, determining which of the potential causes may have triggered the fault can be difficult and often requires an end user (e.g., a service technician) to implement many different potential resolutions before finding the resolution that resolves the fault at issue. It would be desirable to provide a fault diagnostic system that allows end users to readily identify the causes of detected faults and implement resolutions that are likely to resolve the fault at issue.

### SUMMARY

One implementation of the present disclosure is a fault resolution system. The system includes a fault triage system that generates rankings for a plurality of faults detected in a building system and prioritizes the detected faults according to the rankings. The system further includes a fault resolutions database that stores one or more potential resolutions for each of the detected faults and a success rate for each of the potential resolutions. The system further includes a user device that receives the prioritized faults, the potential resolutions, and the success rates from the fault triage system and provides resolution feedback to the fault triage system indicating whether the potential resolutions were successful in resolving the detected faults. The fault triage system uses the resolution feedback to update the success rates stored in the fault resolutions database.

In some embodiments, one or more of the potential resolutions are implemented in the building system and the resolution feedback is based on an effect of implementing the potential resolutions in the building system.

In some embodiments, each of the success rates stored in the fault resolutions database is specific to a fault-resolution pair including a fault and a resolution. The success rate may indicate a likelihood that the resolution will be successful in resolving the fault.

In some embodiments, the fault triage system uses building data from the building system to automatically determine which of the potential resolutions are applicable to the prioritized faults.

In some embodiments, the fault triage system uses the resolution feedback from the user device to confirm that one or more diagnoses for the prioritized faults are true and increases the success rates of the potential resolutions provided to the user device in response to confirming that the diagnoses are true. In some embodiments, the fault triage system uses the resolution feedback from the user device to confirm that one or more diagnoses for the prioritized faults are false and decreases the success rates of the potential resolutions provided to the user device in response to confirming that the diagnoses are false.

In some embodiments, the fault triage system provides the rankings to the user device along with the prioritized faults. The user device may use the rankings to generate and display an ordered list of the prioritized faults according to the rankings.

In some embodiments, the fault triage system uses building data from the building system to automatically detect the plurality of faults in the building system.

Another implementation of the present disclosure is a fault triage system. The system includes a fault prioritizer that generates rankings for a plurality of faults detected in a building system and prioritizes the detected faults according to the rankings. The system further includes a fault resolutions database that stores one or more potential resolutions for each of the detected faults and a success rate for each of the potential resolutions. The system further includes a communications interface that provides the prioritized faults, the potential resolutions, and the success rates to a user device and receives resolution feedback from the user device indicating whether the potential resolutions were successful in resolving the detected faults. The system further includes a success rate updater that receives the resolution feedback from the communications interface and uses the resolution feedback to update the success rates stored in the fault resolutions database.

In some embodiments, one or more of the potential resolutions are implemented in the building system and the resolution feedback is based on an effect of implementing the potential resolutions in the building system.

In some embodiments, each of the success rates stored in the fault resolutions database is specific to a fault-resolution pair including a fault and a resolution. The success rate may indicate a likelihood that the resolution will be successful in resolving the fault.

In some embodiments, the system includes a resolution suggestor that uses building data from the building system to automatically determine which of the potential resolutions are applicable to the prioritized faults. In some embodiments, the resolution suggestor uses the building data to confirm that one or more diagnoses for the prioritized faults are true and annotates the potential resolutions provided to the user device to indicate that the diagnoses are true. In some embodiments, the resolution suggestor uses the building data to confirm that one or more diagnoses for the prioritized faults are false and annotates the potential resolutions provided to the user device to indicate that the diagnoses are false.

In some embodiments, the fault triage system provides the rankings to the user device along with the prioritized faults. The user device may use the rankings to generate and display an ordered list of the prioritized faults according to the rankings.

In some embodiments, the system includes a fault detector that uses building data from the building system to automatically detect the plurality of faults in the building system.

Another implementation of the present disclosure is a method for resolving faults in a building system. The method includes generating rankings for a plurality of faults detected in a building system and prioritizing the detected faults according to the rankings. The method includes retrieving, from a fault resolutions database, one or more potential resolutions for each of the detected faults and a success rate for each of the potential resolutions. The method includes providing the prioritized faults, the potential resolutions, and the success rates to a user device. The method includes receiving resolution feedback from the user device indicating whether the potential resolutions were successful in resolving the detected faults and using the resolution feedback to update the success rates stored in the fault resolutions database.

In some embodiments, the method includes implementing one or more of the potential resolutions in the building system and generating the resolution feedback based on an effect of implementing the potential resolutions in the building system.

In some embodiments, the method includes using building data from the building system to automatically determine which of the potential resolutions are applicable to the prioritized faults.

In some embodiments, the method includes using the resolution feedback from the user device to confirm that one or more diagnoses for the prioritized faults are true or false and annotating the potential resolutions provided to the user device to indicate that the diagnoses are true or false.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a drawing of a building equipped with an HVAC system in which the systems and methods of the present disclosure may be implemented, according to an exemplary embodiment.

FIG. 2 is a block diagram of a waterside system which may be used in conjunction with the HVAC system of FIG. 1, according to an exemplary embodiment.

FIG. 3 is a block diagram of an airside system which may be used in conjunction with the HVAC system of FIG. 1, according to an exemplary embodiment.

FIG. 4 is a block diagram of a building management system in which the systems and methods of the present disclosure may be implemented, according to an exemplary embodiment.

FIG. 5 is a block diagram of a system for detecting, diagnosing, and resolving faults in a building HVAC system, the system including a fault triage system, a fault resolutions database, and a plurality of user devices that provide crowdsourced feedback to the fault triage system, according to an exemplary embodiment.

FIG. 6 is a block diagram illustrating the fault triage system of FIG. 5 in greater detail, according to an exemplary embodiment.

FIG. 7 is a drawing of a login interface which may be generated by the fault triage system and/or user device of FIG. 5, according to an exemplary embodiment.

FIG. 8 is a drawing of a project selection interface which may be generated by the fault triage system and/or user device of FIG. 5, according to an exemplary embodiment.

FIG. 9 is a drawing of a building selection interface which may be generated by the fault triage system and/or user device of FIG. 5, according to an exemplary embodiment.

FIG. 10 is a drawing of an HVAC system selection interface which may be generated by the fault triage system and/or user device of FIG. 5, according to an exemplary embodiment.

FIG. 11 is a drawing of a fault selection interface which may be generated by the fault triage system and/or user device of FIG. 5, according to an exemplary embodiment.

FIG. 12 is a drawing of a fault diagnosis interface which may be generated by the fault triage system and/or user device of FIG. 5, according to an exemplary embodiment.

FIG. 13 is a drawing of a disable fault interface which may be generated by the fault triage system and/or user device of FIG. 5, according to an exemplary embodiment.

FIG. 14 is a drawing of another fault selection interface which may be generated by the fault triage system and/or user device of FIG. 5, according to an exemplary embodiment.

FIG. 15 is a drawing of a fault resolution interface which may be generated by the fault triage system and/or user device of FIG. 5, according to an exemplary embodiment.

FIG. 16 is a flowchart of a process for resolving faults in a building system which may be performed by the fault triage system and/or user device of FIG. 5, according to an exemplary embodiment.

### DETAILED DESCRIPTION

Referring generally to the FIGURES, systems and methods for detecting, diagnosing, and providing suggested resolutions to faults in a building system are shown, according to an exemplary embodiment. The systems and methods described herein may be used by service technicians (e.g., field technicians, maintenance personnel, etc.) or other end users to facilitate fault diagnoses, maintenance, and repair of building systems.

One implementation of the present invention is a fault triage system. The fault triage system may automatically detect and rank (e.g., score, prioritize, etc.) faults in a building system (e.g., a HVAC system) and provide service technicians with a ranked listing of the faults. Each fault may be provided along with one or more suggested resolutions and a success rate corresponding to each suggested resolution. Each success rate indicates the relative likelihood that the corresponding suggested resolution will be successful in resolving the fault. In some embodiments, the suggested resolutions and/or the success rates are based on live data received from the building system. The service technician may implement a suggested resolution (e.g., by making a change or repair to the building system) and may provide feedback regarding whether the suggested resolution was successful in resolving the fault.

Advantageously, the fault triage system uses feedback from a plurality of end users (i.e., crowdsourced feedback) to update the success rates for the suggested resolutions. For example, the fault triage system may increase the success rate for a suggested resolution with respect to a particular fault if the feedback from a service technician indicates that the suggested resolution was successful in resolving the fault. Conversely, the fault triage system may decrease the success rate for a suggested resolution with respect to the fault if the feedback from a service technician indicates that the suggested resolution was not successful in resolving the fault. This allows the fault triage system to identify and prioritize suggested resolutions that are most likely to be successful based on the crowdsourced feedback.

The fault triage system may provide end users with a variety of resources for diagnosing and resolving faults. For example, the fault triage system may generate a list of tools, parts, or other equipment needed to implement a suggested resolution. In some embodiments, the fault triage system automatically retrieves user manuals for equipment experiencing a fault and provides the user manuals to the end user. The fault triage system may retrieve live data from the building system (e.g., diagnostic data and/or measured data values pertaining to a detected fault) and may provide the live data to the end user via a graphical user interface. In some embodiments, the fault triage system uses data from the building system (e.g., installed equipment, equipment efficiencies, equipment configuration settings, etc.) to identify energy savings opportunities that can be implemented in the building system. This allows service technicians to be more prepared, knowledgeable, and efficient when diagnosing and resolving faults in a customer system. These and other features of the fault triage system are described in greater detail below.

### Building Management System and HVAC System

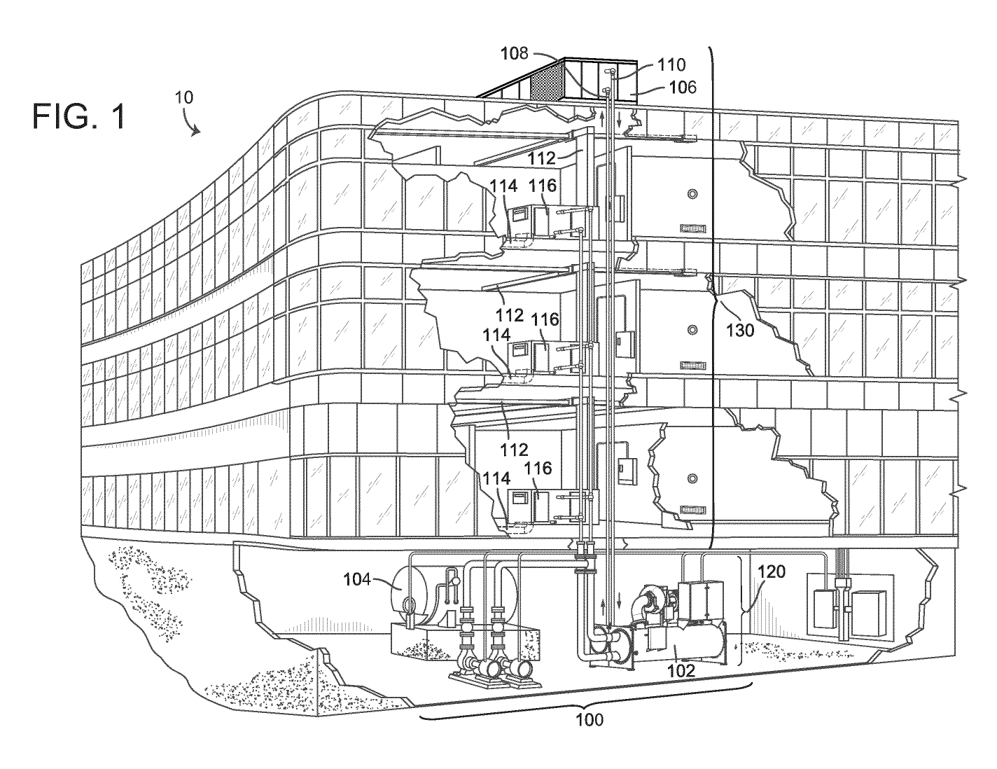

Referring now to FIGS. 1-4, an exemplary building management system (BMS) and HVAC system with which the systems and methods of the present invention may be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, an HVAC system, a security system, a lighting system, a fire alerting system, any other system that is capable of managing building functions or devices, or any combination thereof.

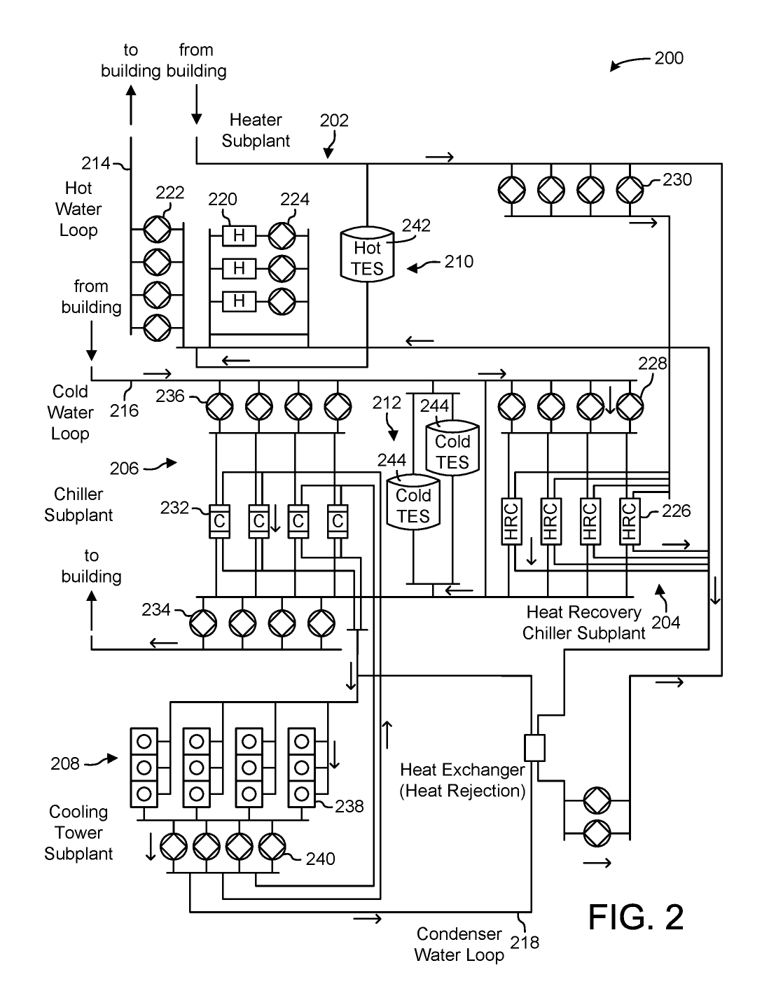

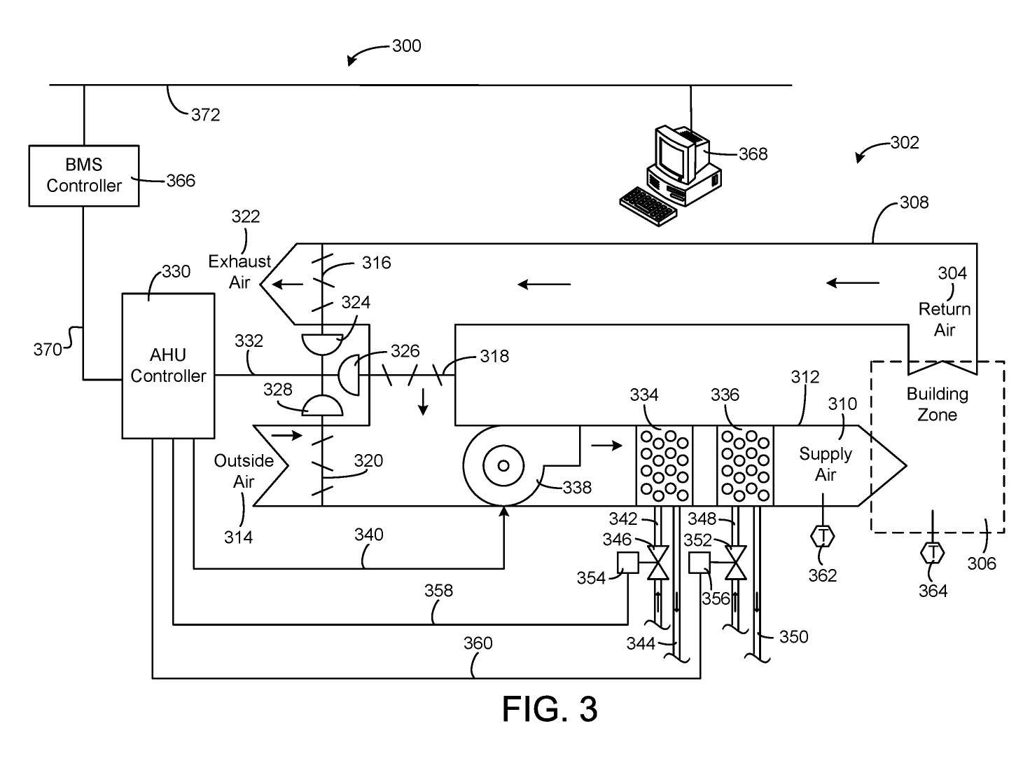

The BMS that serves building 10 includes an HVAC system 100. HVAC system 100 may include a plurality of HVAC devices (e.g., boilers, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units or AHUs 116. For example, airside system 130 is shown to include a separate AHU 116 on each floor or zone of building 10. AHUs 116 may include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate AHUs 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, a block diagram of a waterside system 200 is shown, according to an exemplary embodiment. In various embodiments, waterside system 200 may supplement or replace waterside system 120 in HVAC system 100 or may be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 may be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 and building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., AHUs 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, ammonia, refrigerant, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units, AHUs 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form mixed air. The mixed is subsequently heated by heating coil 336 or cooled by cooling coil 334 and supplied to building zone 306 as supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324,326, and 328 may communicate with an AHU controller 330 via a communications link 332. Actuators 324,326, and 328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324,326, and 328), status information, commissioning information, configuration settings, calibration data, and/or other types of information or data that may be collected, stored, or used by actuators 324,326, and 328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324,326, and 328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and heating coil 336 and provide supply air 310 to building zone 306. AHU controller 330 may communicate with fan 338 via communications link 340 to control a flow rate of supply air 310. In some embodiments, AHU controller 330 controls air pressure and/or airflow within the system by modulating a speed of fan 338. AHU controller 330 may perform temperature control by modulating dampers 316, 318, and 320, cooling coil 334, and/or heating coil 336.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200(e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336.

Still referring to FIG. 3, airside system 300 is shown to include a building management system (BMS) controller 366 and a client device 368. BMS controller 366 may include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

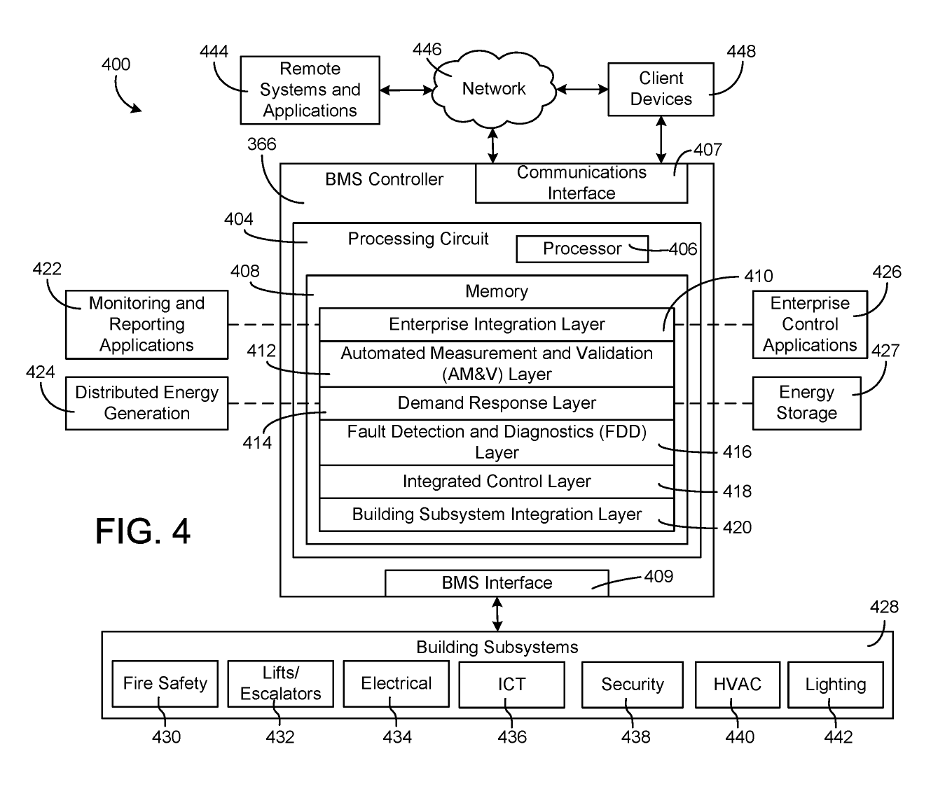

Referring now to FIG. 4, a block diagram of a building management system (BMS) 400 is shown, according to an exemplary embodiment. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a WiFi transceiver for communicating via a wireless communications network. In another example, one or both of interfaces 407, 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 may be distributed across multiple servers or computers (e.g., that can exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases,)ML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

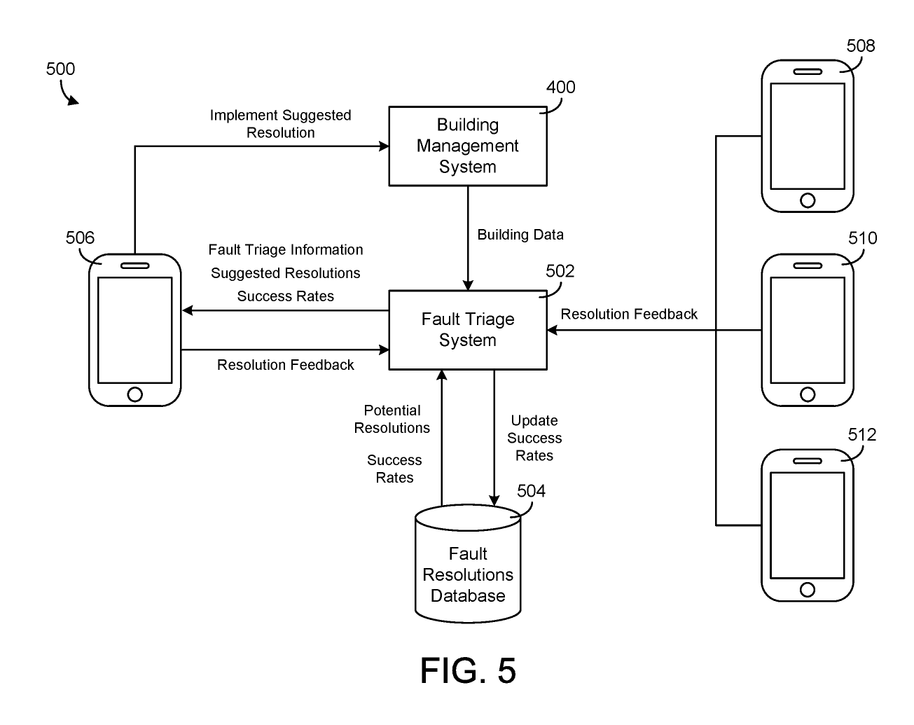

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe. In some embodiments, FDD layer 416 uses the systems and methods described with reference to FIGS. 5-16 to detect, diagnose, and provide suggested resolutions for faults.

### Fault Detection, Diagnostics, and Suggested Resolutions

Referring now to FIG. 5, a system 500 for detecting, diagnosing, and resolving faults in a building system is shown, according to an exemplary embodiment. System 500 may be used in conjunction with any of systems 100-400 to resolve faults in one or more components or subsystems thereof. For example, system 500 may provide fault detection, diagnostics, and resolution services for HVAC system 100, waterside system 200, airside system 300, and/or BMS 400 including any of building subsystems 428 (e.g., HVAC subsystem 440, fire safety subsystem 430, lighting subsystem 442, security subsystem 438, etc.) as described with reference to FIGS. 1-4. BMS 400 is one example of a customer system for which faults can be detected, diagnosed, and resolved using the systems and methods described herein. Although the systems and methods of the present disclosure are described primarily with reference to BMS 400, it should be understood that BMS 400 can be replaced with any type of customer system (e.g., a HVAC system, a security system, a lighting system, an elevator system, etc.) for which faults can be diagnosed and resolved. The remainder of this disclosure uses BMS 400 as an example of such a customer system.

System 500 may be used by service technicians (e.g., field technicians, maintenance personnel, etc.) or other end users to facilitate fault diagnoses, maintenance, and repair of customer systems. For example, system 500 may automatically detect and rank (e.g., score, prioritize, etc.) faults in a customer system and provide service technicians with a ranked listing of the faults. Each fault may be provided along with one or more suggested resolutions and a success rate corresponding to each suggested resolution. Each success rate indicates the relative likelihood that the corresponding suggested resolution will be successful in resolving the fault. In some embodiments, the suggested resolutions and/or the success rates are based on live data received from the customer system. The service technician may implement a suggested resolution (e.g., by making a change or repair to the customer system) and may provide feedback regarding whether the suggested resolution was successful in resolving the fault.

Advantageously, system 500 uses feedback from a plurality of end users (i.e., crowdsourced feedback) to update the success rates for the suggested resolutions. For example, system 500 may increase the success rate for a suggested resolution with respect to a particular fault if the feedback from a service technician indicates that the suggested resolution was successful in resolving the fault. Conversely, system 500 may decrease the success rate for a suggested resolution with respect to the fault if the feedback from a service technician indicates that the suggested resolution was not successful in resolving the fault. This allows system 500 to identify and prioritize suggested resolutions that are most likely to be successful based on the crowdsourced feedback.

System 500 may provide end users with a variety of resources for diagnosing and resolving faults. For example, system 500 may generate a list of tools, parts, or other equipment needed to implement a suggested resolution. In some embodiments, system 500 automatically retrieves user manuals for equipment experiencing a fault and provides the user manuals to the end user. System 500 may retrieve live data from the customer system (e.g., diagnostic data and/or measured data values pertaining to a detected fault) and may provide the live data to the end user via a graphical user interface. In some embodiments, system 500 uses data from the customer system (e.g., installed equipment, equipment efficiencies, equipment configuration settings, etc.) to identify energy savings opportunities that can be implemented in the customer system. These and other features of system 500 may allow service technicians to be more prepared, knowledgeable, and efficient when diagnosing and resolving faults in a customer system.

Still referring to FIG. 5, system 500 is shown to include a fault triage system 502, a fault resolutions database 504, and a plurality of user devices 506, 508, 510, and 512. Fault triage system 502 is shown receiving building data from BMS 400. The building data may include measured values (e.g., measured temperatures, pressures, flowrates, humidities, voltages, etc.), calculated values, configuration settings, control outputs, equipment information, and/or other data relating to the operation and use of BMS 400. In some embodiments, the building data includes measured values that indicate the conditions within a space or zone controlled by BMS 400. For example, the building data may include a measured temperature, humidity, airflow rate, or other measurement obtained from a sensor located within a building space.

In some embodiments, the building data includes measured or calculated values relating to the operation of building equipment. For example, the building data may include measurements of various states within a HVAC device or upstream/downstream of the HVAC device (e.g., refrigerant pressures, temperatures or flow rates; chiller inlet temperatures outlet temperatures, or chilled fluid flow rates, heater inlet temperatures, outlet temperatures, or heated fluid flow rates; AHU supply air temperatures, pressures, or flowrates; etc.). The building data may include control setpoints, control signals, or other information communicated between devices of BMS 400. In some embodiments, the building data includes temporal (i.e., time-series) data indicating the performance of BMS 400 and the various components thereof.

In some embodiments, the building data includes performance metrics relating to one or more subsystems of BMS 400 and/or individual devices thereof. For example, the building data may include a calculated efficiency or other measure of performance for an AHU, chiller, heater, fan, or other device of BMS 400. In some embodiments, the building data includes configuration settings or other details relating to the equipment within BMS 400. For example, the building data may include controller tuning parameters, control logic, model parameters for a model-based control system (e.g., regression parameters), equipment identities, model numbers, capacities, efficiencies, or other information describing the operation of BMS 400.

Fault triage system 502 may use the building data to detect faults in BMS 400. Fault triage system 502 may use any of a variety of fault detection techniques. For example, fault triage system 502 may compare a data point (e.g., a measured or calculated value) provided by the building data with one or more thresholds to determine whether the value of the data point is within a specified range. If the value of the data point is within the specified range, fault triage system 502 may determine that no fault is detected with respect to the data point (e.g., zone temperature within minimum and maximum bounds). However, if the value of the data point is not within the specified range, fault triage system 502 may determine that a fault is detected with respect to the data point (e.g., AHU supply air temperature too warm or cold, chiller efficiency too low, etc.).

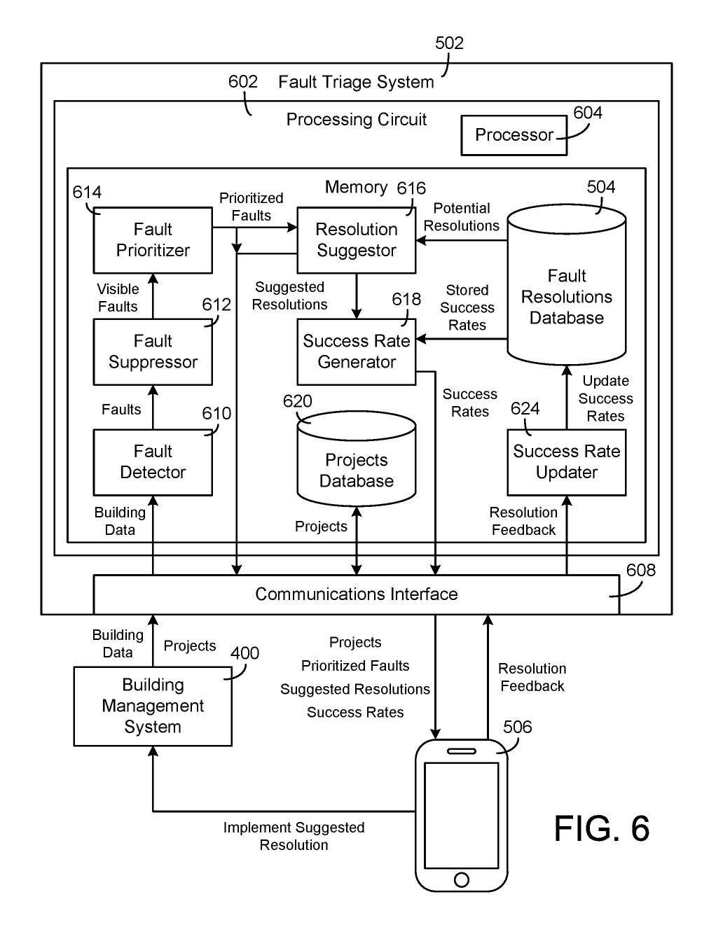

In some embodiments, fault triage system 502 detects faults by performing a temporal analysis of the building data. For example, the building data may include measured or calculated values that exhibit statistical characteristics (e.g., mean, standard deviation, exponentially-weighted moving average (EWMA), etc.) and provide information about how the corresponding system or process (e.g., a temperature control process, a flow control process, etc.) is performing in terms of error from its setpoint. Fault triage system 502 may use the statistical characteristics of the building data to detect changes in BMS 400 that may qualify as faults, for example, if the magnitude of the change exceeds a threshold or if the change occurs rapidly. Fault triage system 502 may detect faults at the data point level (e.g., measured temperature or pressure outside specified bounds), equipment level (e.g., specific chiller, specific AHU, specific terminal unit, etc.), or at the system or subsystem level (e.g., system efficiency or capacity below a threshold). Several exemplary fault detection techniques which may be used by fault triage system 502 are described in greater detail with reference to FIG. 6.

Fault triage system 502 may perform fault suppression to limit the number of faults shown to a user. In some embodiments, fault triage system 502 suppresses faults based on a hierarchical or control relationship between systems, devices, or data points within BMS 400. Fault triage system 502 may use a causal relationship model or system hierarchy to identify causal relationships and/or parent-child relationships between HVAC devices. For example, the causal relationship model may specify that a particular chiller provides chilled fluid to a particular AHU which delivers chilled air to a building zone. Fault triage system 502 may use the relationships between HVAC devices to suppress faults in downstream (e.g., child) HVAC devices that may be caused by faults in upstream (e.g., parent) HVAC devices. For example, fault triage system 502 may suppress faults indicating that the AHU discharge air temperature (DA-T) is too high when the upstream chiller is experiencing a fault that would affect the AHU discharge air temperature (e.g., chilled fluid temperature too high). The fault suppression performed by fault triage system 502 is described in greater detail with reference to FIG. 6.

Fault triage system 502 may rank and prioritize the detected faults. In various embodiments, fault triage system 502 ranks and prioritizes each of the detected faults or only the faults that are not suppressed as a result of the fault suppression (i.e., the visible faults). Fault triage system 502 may generate and assign rankings to various faults based on predetermined ranking criteria. In some embodiments, the ranking criteria include a plurality of weighted factors that describe the fault and/or the effects of the fault. For example, the factors may include fault severity, customer importance, overall fault duration, average fault duration, the number of occurrences of the fault, the number of child faults estimated to be caused by the fault, the monetary value of the fault, the type of system or device associated with the fault, etc.

Fault triage system 502 may determine (e.g., generate, assign, calculate, etc.) a value for each of the factors based on the building data. For example, a fault that has been present for several hours or days may be assigned a relatively greater value for the fault duration factor, whereas a fault that occurred recently may be assigned a relatively lesser value for the fault duration factor. Fault triage system 502 may assign a weight to each of the factors and use the weighted factors to calculate a ranking or score for each of the faults. The weights may indicate the relative importance of the factors relative to each other. The weights assigned to each of the factors may be determined by subject matter experts, set by a user, or automatically determined by fault triage system 502. In some embodiments, fault triage system 502 calculates an overall ranking for each fault by multiplying the value of each factor by the corresponding weight and summing the resultant products.

Fault triage system 502 may prioritize the faults based on their respective rankings. In some embodiments, fault triage system 502 prioritizes faults with a higher ranking over faults with a lower ranking. Fault triage system 502 may generate an ordered list of the faults in which the order is based on the ranking or priority of each fault. Higher priority faults may be listed before lower priority faults in the ordered list. Fault triage system 502 may provide the ordered list of faults along with their ratings to user device 506. This is shown in FIG. 5 as fault triage information. Fault triage information may include the detected faults, the ranking or priority assigned to each fault, and/or other attributes of the fault (e.g., fault duration, number of suppressed faults, etc.).

For each of the prioritized faults, fault triage system 502 may identify one or more potential resolutions. Potential resolutions may include fault diagnoses (e.g., root causes or reasons for the fault) and/or suggested actions that can be performed to resolve the fault. For example, a fault indicating that the discharge air temperature (DA-T) of an AHU is too high may be caused by a fan not working properly, a chilled water supply that is too warm, ductwork issues, or any of a variety of potential root causes. Each of these root causes is a potential fault diagnosis. Each fault diagnosis may have a corresponding action or set of actions that can be performed to resolve the fault. For example, a diagnosis that the fan is not working properly may be resolved by repairing or replacing the fan.

Advantageously, fault triage system 502 may retrieve the potential resolutions from fault resolutions database 504. Fault resolutions database 504 may store one or more fault diagnoses for each fault that may occur. Fault resolutions database 504 may also store one or more suggested actions that can be performed to resolve each fault. When a fault is detected, fault triage system 502 may access fault resolutions database 504 to identify the potential fault diagnoses and the corresponding corrective actions.

In some embodiments, fault resolutions database 504 stores a success rate for each potential resolution. The success rate may indicate the relative likelihood that the potential resolution will resolve a particular fault. Each success rate may be specific to a particular resolution as that resolution pertains to a particular fault or combination of faults. In other words, each success rate may apply to a particular fault-resolution pair. For example, the potential resolution of replacing or repairing a supply air fan may have a relatively high success rate with respect to an AHU supply air temperature fault since replacing a supply air fan may be likely to resolve the fault. However, the same resolution may have a significantly lower success rate with respect to a chiller refrigerant flow rate fault since replacing a supply air fan may have little or no effect on the refrigerant flow rate.

In some embodiments, fault resolutions database 504 is initially populated with faults, potential resolutions, and success rates by a group of subject matter experts (SMEs). For each fault that may occur, the SMEs may identify one or more potential resolutions and an estimated success rate that applies to the fault-resolution pair. After fault resolutions database 504 is initially populated, the potential resolutions and success rates may be provided to end users to facilitate fault diagnostics and resolution. For example, fault triage system 502 is shown providing suggested resolutions and success rates to user device 506 along with the fault triage information. The suggested resolutions may include some or all of the potential resolutions for a particular fault, as indicated by the information stored in fault resolutions database 504. In some embodiments, the suggested resolutions include a subset of the potential resolutions. For example, fault triage system 502 may modify the set of potential resolutions for a particular fault based on the building data received from BMS 400 (e.g., by removing potential resolutions that are not applicable based on the building data).

In some embodiments, fault triage system 502 uses the building data from BMS 400 to automatically determine whether each of the potential resolutions from fault resolutions database 504 is applicable to the fault at issue. For example, one of the potential diagnoses for a fault indicating low airflow to a building zone may be that an emergency airflow damper within an AHU is closed. Fault triage system 502 may use the building data to automatically determine whether the emergency airflow damper is open or closed (e.g., based on measurements from a damper position sensor or airflow sensor associated with the damper, by running a diagnostic damper testing process, etc.).

If a particular diagnosis is confirmed or suggested by the building data, fault triage system 502 may cause the corresponding potential resolution to be highlighted or marked as a potential issue when presented via user device 506. Similarly, if the diagnosis is confirmed or suggested to be incorrect by the building data, fault triage system 502 may mark the corresponding potential resolution as not applicable or may remove the potential resolution from the list of suggested resolutions provided to user device 506. In this way, fault triage system 502 may generate a list of suggested resolutions that are customized to the fault at issue based on the building data and/or configuration of BMS 400. Fault triage system 502 may provide the suggested resolutions along with the fault triage information and success rates to user device 506.

User device 506 may be an electronic device capable of receiving and presenting the fault triage information (i.e., detected and prioritized faults), suggested resolutions, and success rates from fault triage system 502. In some embodiments, user device 506 is a mobile device (e.g., a smart phone, a tablet, a laptop computer, a PDA, a portable electronic device, etc.). In other embodiments, user device 506 is a desktop computer, a user workstation, a client terminal, or other non-mobile computing device. User device 506 may be configured (e.g., by installing an application) to present the received information to an end user to facilitate fault diagnostics and resolution.

In some embodiments, user device 506 is a portable electronic device which may be used by a service technician at a customer site. For example, the service technician may travel to the location of BMS 400 and run the application installed on user device 506 to retrieve and present the fault triage information pertaining to BMS 400. User device 506 may also retrieve and present the suggested resolutions and success rates from fault triage system 502 and/or from fault resolutions database 504. User device 506 may display the ordered list of prioritized faults along with their suggested resolutions and success rates. The service technician can use the information from fault triage system 502 to diagnose the detected faults and implement one or more of the suggested resolutions. After implementing a suggested resolution, user device 506 may prompt the service technician to specify whether the suggested resolution was successful in resolving the fault.

Advantageously, fault triage system 502 may be configured to receive feedback from user device 506 indicating whether the suggested resolution was successful in resolving the fault. Fault triage system 502 may use the resolution feedback to update the success rate of the suggested resolution with respect to the fault at issue. For example, fault triage system 502 may increase the success rate for a suggested resolution with respect the fault at issue if the resolution feedback indicates that the suggested resolution was successful in resolving the fault. Conversely, fault triage system 502 may decrease the success rate for the suggested resolution if the resolution feedback indicates that the suggested resolution was not successful in resolving the fault.

Fault triage system 502 may use crowdsourced resolution feedback from a plurality of user devices (e.g., user devices 506, 508, 510, 512, etc.) to update the success rates stored in fault resolutions database 504. Crowdsourced resolution feedback may be received from multiple different user devices based on whether the suggested resolutions were successful to resolve faults in multiple different customer systems. For example, fault triage system 502 may receive crowdsourced resolution feedback from user devices located in different geographic regions (e.g., different cities, different states, different countries, etc.) and may use the crowdsourced resolution feedback to update the success rates stored in a centralized fault resolution database 504. This allows fault triage system 502 to modify the stored success rates to more accurately reflect actual field conditions and allows users to share information with one another. When the same fault is detected again (e.g., in BMS 400 or another customer system at a different location), fault triage system 502 may identify and prioritize suggested resolutions that are most likely to be successful based on the crowdsourced feedback.

In some embodiments, fault triage system 502 segregates success rates by region. For example, crowdsourced feedback from user devices located in a first region may be used to update success rates for the first region, whereas crowdsourced feedback from user devices located in a second region may be used to update success rates for the second region. In some embodiments, system 500 includes multiple instances of fault resolutions database 504 (e.g., multiple databases, multiple file structures within a single database, etc.). Each instance of fault resolutions database 504 may store the fault resolutions and success rates for a particular region to allow different regions to have different success rates for the same fault-resolution pair.

### Fault Triage System

Referring now to FIG. 6, a block diagram illustrating fault triage system 502 in greater detail is shown, according to an exemplary embodiment. Fault triage system 502 is shown to include a communications interface 608. Communications interface 608 may include wired or wireless communications interfaces (e.g., jacks, antennas, transmitters, receivers, transceivers, wire terminals, etc.) for conducting data communications with building management system 400, user device 506, and/or other external systems or devices. In various embodiments, communications via interface 608 may be direct (e.g., local wired or wireless communications) or via a communications network (e.g., a WAN, the Internet, a cellular network, etc.). For example, communications interface 608 can include an Ethernet card and port for sending and receiving data via an Ethernet-based communications link or network, a WiFi transceiver for communicating via a wireless communications network, a cellular or mobile phone communications transceiver, a power line communications interface, or any other type of wired or wireless communications interface.

Communications interface 608 is shown receiving building data and projects from BMS 400. As previously described, building data may include measured values (e.g., measured temperatures, pressures, flowrates, humidities, voltages, etc.), calculated values, configuration settings, control outputs, equipment information, and/or other data relating to the operation and use of BMS 400. Projects may include requests for equipment installation, maintenance, service, repairs, inspections, consultations, or other activities performed by a service technician. Projects may be submitted by a user or automatically generated by BMS 400. For example, BMS 400 may be configured to automatically generate maintenance projects (e.g., service calls) and submit the maintenance projects to fault triage system 502. In some embodiments, BMS 400 generates maintenance or repair projects in response to detecting a fault in BMS 400. For example, BMS 400 may be configured to automatically request equipment service when a fault is detected. In some embodiments, fault triage system 502 integrates and/or creates service system projects used to organize many different BMS subsystems. In other embodiments, projects are automatically generated based on the building data from BMS 400 (e.g., generating an equipment service project when a fault is detected).

Projects may be stored in a projects database 620. In various embodiments, projects database 620 may be a component of fault triage system 502 or an external database. In some embodiments, projects database 620 stores projects along with an indication of a fault associated with the projects. Fault indications may be detected automatically based on the building data from BMS 400. Alternatively, faults may be reported by a user. For example, a user may identify a faulty article of building equipment or a fault symptom when generating and submitting projects to fault triage system 502. Projects may be stored along with a site name (e.g., a name or descriptor of a customer site associated with the project), a project name, a project number, or other attributes that describe the projects.

User device 506 may request a list of projects from fault triage system 502. Fault triage system 502 may provide projects and/or customer sites associated with the projects to user device 506 via communications interface 608. User device 506 may present the list of projects and/or customer sites to an end user via a user interface of user device 506. The end user (e.g., a service technician) may view the list of projects and/or customer sites and select a project or customer site via user device 506. When a project or customer site is selected, fault triage system 502 may provide details of the project or customer site to user device 506 via communications interface 608. Project or site details may include, for example, faults associated with the customer site, suggested resolutions, success rates, required tools, equipment manuals, and/or other information that can be used by the service technician to prepare for the project and/or for a visit to the customer site. When a project is completed, user device 506 may provide fault triage system 502 with resolution feedback via communications interface 608. Fault triage system 502 may use the resolution feedback to update the success rates in fault resolutions database 504.

Still referring to FIG. 6, fault triage system 502 is shown to include a processing circuit 602 including a processor 604 and memory 606. Processor 604 may be a general purpose or specific purpose processor, an application specific integrated circuit (ASIC), one or more field programmable gate arrays (FPGAs), a group of processing components, or other suitable processing components. Processor 604 is configured to execute computer code or instructions stored in memory 606 or received from other computer readable media (e.g., CDROM, network storage, a remote server, etc.).

Memory 606 may include one or more devices (e.g., memory units, memory devices, storage devices, etc.) for storing data and/or computer code for completing and/or facilitating the various processes described in the present disclosure. Memory 606 may include random access memory (RAM), read-only memory (ROM), hard drive storage, temporary storage, non-volatile memory, flash memory, optical memory, or any other suitable memory for storing software objects and/or computer instructions. Memory 606 may include database components, object code components, script components, or any other type of information structure for supporting the various activities and information structures described in the present disclosure. Memory 606 may be communicably connected to processor 604 via processing circuit 602 and may include computer code for executing (e.g., by processor 604) one or more processes described herein. When processor 604 executes instructions stored in memory 606, processor 604 generally configures fault triage system 502 (and more particularly processing circuit 602) to complete such activities.

Still referring to FIG. 6, fault triage system 502 is shown to include a fault detector 610. Fault detector 610 is shown receiving the building data from BMS 400. Fault detector 610 may use any of a variety of fault detection techniques to detect faults in BMS 400 based on the building data. For example, fault detector 610 may compare a data point (e.g., a measured or calculated value) provided by the building data with one or more thresholds to determine whether the value of the data point is within a specified range. If the value of the data point is within the specified range, fault detector 610 may determine that no fault is detected with respect to the data point (e.g., zone temperature within minimum and maximum bounds). However, if the value of the data point is not within the specified range, fault detector 610 may determine that a fault is detected with respect to the data point (e.g., AHU supply air temperature too warm or cold, chiller efficiency too low, etc.).

In some embodiments, fault detector 610 detects faults by performing a temporal analysis of the building data. For example, the building data may include measured or calculated values that exhibit statistical characteristics (e.g., mean, standard deviation, exponentially-weighted moving average (EWMA), etc.) and provide information about how the corresponding system or process (e.g., a temperature control process, a flow control process, etc.) is performing in terms of error from its setpoint. Fault detector 610 may use the statistical characteristics of the building data to detect changes in BMS 400 that may qualify as faults, for example, if the magnitude of the change exceeds a threshold or if the change occurs rapidly. Fault detector 610 may use the building data to detect faults at the equipment level (e.g., specific chiller, specific AHU, specific terminal unit, etc.) or at the system or subsystem level.

Several exemplary fault detection techniques which may be used by fault detector 610 are described in U.S. Pat. No. 9,069,338 titled “Systems and Methods for Statistical Control and Fault Detection in a Building Management System,” U.S. patent application Ser. No. 14/273,381 titled “Automated Fault Detection and Diagnostics in a Building Management System,” U.S. patent application Ser. No. 14/572,375 titled “Fault Detection and Diagnostic System for a Refrigeration Circuit,” U.S. patent application Ser. No. 14/320,203 titled “Systems and Methods for Using Rule-Based Fault Detection in a Building Management System,” and U.S. patent application Ser. No. 14/744,761 titled “Building Management System With Voting-Based Fault Detection and Diagnostics.” All of these patents and patent applications are incorporated by reference herein in their entireties. Fault detector 610 may provide fault indications to fault suppressor 612.

Still referring to FIG. 6, fault triage system 502 is shown to include a fault suppressor 612. Fault suppressor 612 may perform fault suppression to limit the number of faults shown to a user. In some embodiments, fault suppressor 612 suppresses faults based on a hierarchical or control relationship between systems, devices, or data points within BMS 400. Fault suppressor 612 may use a causal relationship model or system hierarchy to identify causal relationships and/or parent-child relationships between HVAC devices. For example, the causal relationship model may specify that a particular chiller provides chilled fluid to a particular AHU which delivers chilled air to a building zone.

Fault suppressor 612 may use the relationships between HVAC devices to suppress faults in downstream (e.g., child) HVAC devices that may be caused by faults in upstream (e.g., parent) HVAC devices. For example, fault suppressor 612 may suppress faults indicating that the AHU discharge air temperature (DA-T) is too high when the upstream chiller is experiencing a fault that would affect the AHU discharge air temperature (e.g., chilled fluid temperature too high). An exemplary causal relationship model which may be used by fault suppressor 612 is described in greater detail in U.S. Patent Application No. 12/898,589 titled “Creation and Use of Causal Relationship Models in Building Management Systems and Applications,” the entirety of which is incorporated by reference herein.

In some embodiments, fault suppressor 612 groups similar faults and/or suppresses multiple instances of the same fault. For example, if the same fault is detected in a HVAC device multiple times within a given time period, fault suppressor 612 may suppress all but one of the faults to avoid displaying duplicative information. In some embodiments, fault suppressor 612 replaces multiple similar fault indications over a time period with a single fault indication that represents the multiple similar fault indications. The single fault indication may indicate the duration of a time period over which the faults are detected and/or the number of faults detected within the time period (e.g., 14 faults in last 72 hours).

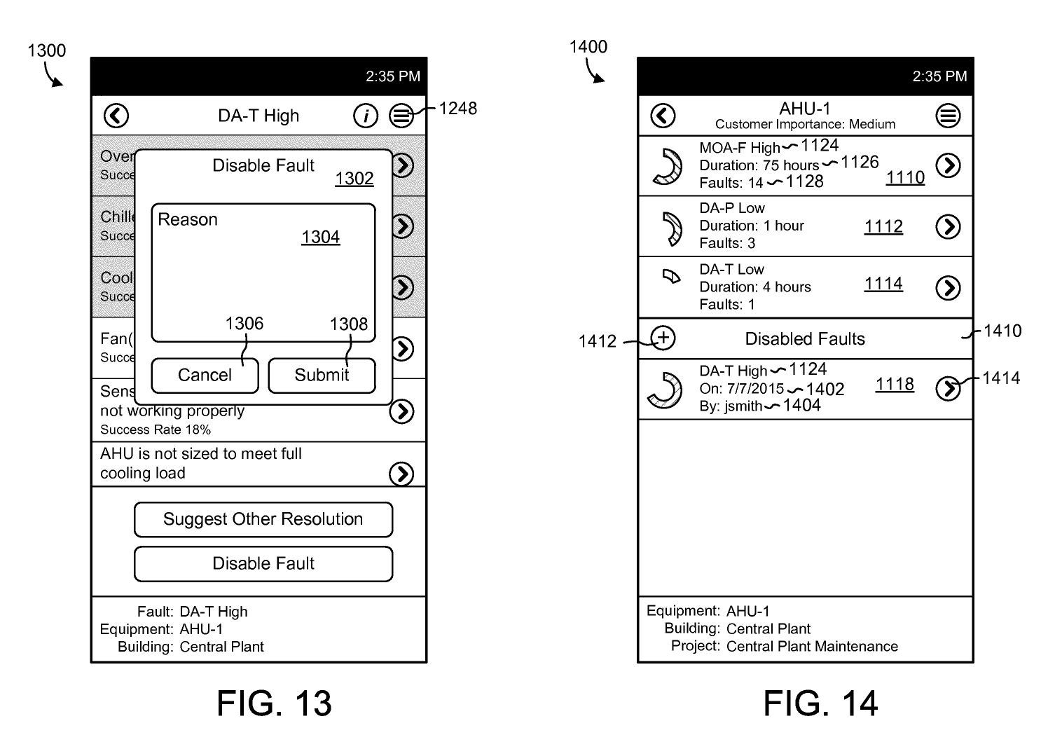

In some embodiments, fault suppressor 612 suppresses faults based on feedback from a user. For example, fault suppressor 612 may receive input from user device 506 indicating that a particular fault should be suppressed or disabled. In response to receiving such an input, fault suppressor 612 may cause the disabled fault to be suppressed, hidden, or removed from a list of faults presented to the user. In some embodiments, fault suppressor 612 generates a graphical user interface (shown in FIGS. 13-14) for disabling and re-enabling faults.

Still referring to FIG. 6, fault triage system 502 is shown to include a fault prioritizer 614. Fault prioritizer 614 is shown receiving visible (i.e., non-suppressed) faults from fault suppressor 612. Fault prioritizer 614 may be configured to rank and prioritize the visible faults. Fault prioritizer 614 may generate and assign rankings to various faults based on predetermined ranking criteria. In some embodiments, the ranking criteria include a plurality of weighted factors that describe the fault and/or the effects of the fault. For example, the factors may include fault severity, customer importance, overall fault duration, average fault duration, the number of occurrences of the fault, the number of child faults estimated to be caused by the fault, the monetary value of the fault, the type of system or device associated with the fault, etc. Fault prioritizer 614 may determine (e.g., generate, assign, calculate, etc.) a value for each of these factors based on the building data.

The fault severity factor may rate the severity or magnitude of the fault. In some embodiments, the fault severity indicates the difference between the value of a faulty data point and a fault threshold. Larger deviations from the fault threshold may correspond to more severe faults (e.g., temperature out of range by 45 degrees), whereas smaller deviations from the fault threshold may correspond to less severe faults (e.g., temperature out of range by 8 degrees). In some embodiments, fault severity depends on the type of fault and/or the identity of the faulty equipment. For example, faults in a critical system (e.g., a power system, a security system, etc.) may be assigned a higher fault severity than faults in a non-critical system. Fault prioritizer 614 may determine a fault severity value for each of the visible faults. In some embodiments, initial values for fault severity may be determined by subject matter experts (SMEs) and stored in fault resolutions database 504.

The customer importance factor may quantify the importance of the fault to a customer or other user affected by the fault (e.g., low, medium, high, etc.). In some embodiments, the customer importance factor is provided by the customer when a fault is reported or when a project is generated/submitted. In other embodiments, the customer importance factor is automatically assigned to the fault by fault prioritizer 614 based on predetermined customer importance ratings. For example, the customer may specify that a high customer importance value should be assigned to faults associated with a particular space (e.g., the CEO's office) or a particular type or set of building equipment (e.g., data center equipment, HVAC equipment, etc.), whereas a lower customer importance should be assigned to faults associated with other spaces (e.g., storage closets) or other building equipment (e.g., vending machines, decorative lighting, etc.). When a fault is detected, fault prioritizer 614 may assign a customer importance to the fault based on the attributes of the fault and the customer importance criteria.

The overall fault duration factor may quantify the total amount of time the fault has been present or active in the customer system over a given time period, referred to herein as the calculation period. For example, if the fault was first detected 8 hours ago and has been continuously active since initial detection, the overall fault duration may be 8 hours. If the fault occurs intermittently over the calculation period, the overall fault duration factor may be calculated by summing the durations of the time periods during which the fault is active. For example, if the fault is active for 2 hours, then inactive for 3 hours, then active again for 4 hours, the overall fault duration may be 6 hours. In some embodiments, fault prioritizer 614 divides the calculation period into a plurality of discrete time periods and determines whether the fault was detected in each of the discrete time periods. Time periods that include a fault detection may be classified as faulty time periods, whereas time periods that do not include a fault detection may be classified as non-faulty time periods. Fault prioritizer 614 may calculate the overall fault duration by summing the durations of the faulty time periods.

The average fault duration factor may quantify the average duration of multiple occurring faults over the calculation period. Multiple occurring faults may include multiple detections of the same fault or multiple independent faults within the same category or grouping. In some embodiments, multiple occurring faults are partially suppressed by fault suppressor 612 so that only one instance of the multiple occurring fault is shown to a user. Fault prioritizer 614 may calculate the average duration of the multiple occurring faults by summing the durations of the multiple occurring fault and dividing by the number of multiple occurring faults.

The number of occurrences factor may quantify the total number of times the fault has occurred over the calculation period. Faults that occur more frequently may have a larger number of occurrences, whereas faults that occur less frequently may have a smaller number of occurrences. In some embodiments, fault prioritizer 614 divides the calculation period into a plurality of discrete time periods and determines whether the fault was detected in each of the discrete time periods. Time periods that include a fault detection may be classified as faulty time periods, whereas time periods that do not include a fault detection may be classified as non-faulty time periods. Fault prioritizer 614 may calculate the number of occurrences by counting the number of fault detections and/or faulty time periods.

The number of child faults may quantify the total number of faults estimated to be caused by the fault. For example, faults in an upstream or parent device (e.g., a chiller) may cause a large number of faults in downstream or child systems or devices (e.g., AHU temperature sensors, zone temperature sensors, etc.). In some embodiments, fault prioritizer 614 uses a causal relationship model or system hierarchy to identify child systems or devices for each detected fault. If a fault is detected in a parent device and the parent device has one or more child systems or devices also experiencing a fault, fault prioritizer 614 may determine that the faults in the child systems or devices may be caused by the fault in the parent device. Fault prioritizer 614 may calculate the number of child faults by counting the total number of faults that may be caused by the fault.

The monetization factor may quantify the cost of the fault if left uncorrected. Some faults may result in increased energy consumption or less efficient equipment operation, which increases the cost of operating the customer system. In some embodiments, fault prioritizer 614 estimates the monetary cost of a fault by predicting an increase in energy consumption that will result from the fault. Fault prioritizer 614 may convert the increase in energy consumption into a monetary value by multiplying the increase in energy consumption by a cost per unit of energy. Energy cost information may be received from a utility that supplies resources (e.g., electricity, natural gas, water, etc.) to the customer system. In some embodiments, the energy cost information includes both prices per unit of energy (e.g., $/kWh) and electric demand charges specifying a cost per unit of power at the maximum power usage (e.g., $/kW)

Fault prioritizer 614 may assign a weight to each of the factors and use the weighted factors to calculate a ranking or score for each of the faults. The weights may indicate the importance of the factors relative to each other. The weights assigned to each of the factors may be determined by subject matter experts, set by a user, or automatically determined by fault prioritizer 614. In some embodiments, fault prioritizer 614 calculates an overall ranking for each fault by multiplying the value of each factor by the corresponding weight and summing the resultant products. For example, the ranking assigned to a fault may be calculated using the following equation:

R=X_{FS}*W_{FS}+X_{CI}*W_{CI}+X_{OD}*W_{OD}+X_{AD}*W_{AD}+X_{NO}*W_{NO}+X_{CF}*W_{CF}+X_{M}*W_{M}

where X_{FS} and W_{FS} are the value and weight assigned to the fault severity factor, X_{CI} and W_{CI} are the value and weight assigned to the customer importance factor, X_{OD} and W_{OD} are the value and weight assigned to the overall fault duration factor, X_{AD} and W_{AD} are the value and weight assigned to the average fault duration factor, X_{NO} and W_{NO} are the value and weight assigned to the number of occurrences factor, X_{CF} and W_{CF} are the value and weight assigned to the number of child faults factor, and X_{M} and W_{M} are the value and weight assigned to the monetization factor.

Fault prioritizer 614 may prioritize the faults based on their respective rankings. In some embodiments, fault prioritizer 614 prioritizes faults with a higher ranking over faults with a lower ranking. Fault prioritizer 614 may generate an ordered list of the faults in which the order is based on the ranking or priority of each fault. Higher priority faults may be listed before lower priority faults in the ordered list. Fault prioritizer 614 may provide the prioritized faults along with their ratings to user device 506. The prioritized faults may include the detected faults, the ranking or priority assigned to each fault, and/or other attributes of the fault (e.g., fault duration, number of suppressed faults, etc.). Fault prioritizer 614 may also provide the prioritized faults to resolution suggestor 616.

Still referring to FIG. 6, fault triage system 502 is shown to include a resolution suggestor 616. Resolution suggestor 616 may identify one or more potential resolutions for each of the prioritized faults. Resolution suggestor 616 may retrieve the potential resolutions from fault resolutions database 504. As previously described, fault resolutions database 504 may store one or more fault diagnoses for each fault that may occur. Fault resolutions database 504 may also store one or more suggested actions that can be performed to resolve each fault. When a fault is detected, resolution suggestor 616 may access fault resolutions database 504 to identify the potential fault diagnoses and the corresponding corrective actions.

Resolution suggestor 616 may use the potential resolutions to generate a set of suggested resolutions. The suggested resolutions may include some or all of the potential resolutions for a particular fault, as indicated by the information stored in fault resolutions database 504. In some embodiments, the suggested resolutions include a subset of the potential resolutions retrieved from fault resolutions database 504. For example, fault resolution suggestor 616 may modify the set of potential resolutions for a particular fault based on the building data received from BMS 400 (e.g., by removing potential resolutions that are not applicable based on the building data).

In some embodiments, resolution suggestor 616 uses the building data from BMS 400 to automatically determine whether each of the potential resolutions from fault resolutions database 504 is applicable to the fault at issue. If a particular diagnosis is confirmed or suggested by the building data, resolution suggestor 616 may cause the corresponding potential resolution to be highlighted or marked as a potential issue when presented via user device 506. Similarly, if the diagnosis is confirmed or suggested to be incorrect by the building data, resolution suggestor 616 may mark the corresponding potential resolution as not applicable or may remove the potential resolution from the list of suggested resolutions provided to user device 506. In this way, resolution suggestor 616 may generate a list of suggested resolutions that are customized to the fault at issue based on the building data and/or configuration of BMS 400. Resolution suggestor 616 may provide the suggested resolutions to success rate generator 618 and to user device 506.

Still referring to FIG. 6, fault triage system 502 is shown to include a success rate generator 618. Success rate generator 618 may be configured to determine a success rate for each of the suggested resolutions with respect to the fault at issue. In some embodiments, success rate generator 618 retrieves the success rates from fault resolutions database 504. As previously described, fault resolutions database 504 may store a success rate for each potential resolution. The success rate may indicate the relative likelihood that the potential resolution will resolve a particular fault. Each success rate may be specific to a particular resolution as that resolution pertains to a particular fault or combination of faults. In other words, each success rate may apply to a particular fault-resolution pair.

In some embodiments, success rate generator 618 modifies the success rates retrieved from fault resolutions database 504 based on the building data from BMS 400. For example, if the building data suggests a particular diagnosis for the detected fault, success rate generator 618 may increase the success rate of the corrective actions corresponding to the suggested diagnosis. However, if the building data confirms or suggests that the diagnosis does not apply to the fault at issue, success rate generator 618 may decrease the success rate of the corrective actions corresponding to the diagnosis. In some embodiments, success rate generator 618 modifies the success rates based on the co-occurrence of multiple faults. For example, if multiple faults are detected which could potentially be caused by the same underlying root cause, success rate generator 618 may increase the success rate of the corrective actions corresponding to the shared root cause. Success rate generator 618 may provide the suggested resolutions to user device 506.

Still referring to FIG. 6, fault triage system 502 is shown to include a success rate updater 624. Success rate updater 624 may be configured to update the success rates stored in fault resolutions database 504 based on resolution feedback from user device 506 and other user devices. For example, after implementing a suggested resolution, user device 506 may prompt an end user to specify whether the suggested resolution was successful in resolving the fault. Success rate updater 624 may receive feedback from user device 506 indicating whether the suggested resolution was successful in resolving the fault. Success rate updater 624 may use the resolution feedback to update the success rate of the suggested resolution with respect to the fault at issue. For example, success rate updater 624 may increase the success rate for a suggested resolution with respect the fault at issue if the resolution feedback indicates that the suggested resolution was successful in resolving the fault. Conversely, success rate updater 624 may decrease the success rate for the suggested resolution if the resolution feedback indicates that the suggested resolution was not successful in resolving the fault.

In some embodiments, success rate updater 624 uses crowdsourced resolution feedback from a plurality of user devices to update the success rates stored in fault resolutions database 504. Crowdsourced resolution feedback may be received from multiple different user devices based on whether the suggested resolutions were successful to resolve faults in multiple different customer systems. For example, success rate updater 624 may receive crowdsourced resolution feedback from user devices located in different geographic regions (e.g., different cities, different states, different countries, etc.) and may use the crowdsourced resolution feedback to update the success rates stored in a centralized fault resolution database 504. This allows success rate updater 624 to modify the stored success rates to more accurately reflect actual field conditions and allows users to share information with one another. When the same fault is detected again (e.g., in BMS 400 or another customer system at a different location), fault triage system 502 may identify and prioritize suggested resolutions that are most likely to be successful based on the crowdsourced feedback.

In some embodiments, fault triage system 502 uses crowdsourced feedback to add new fault resolutions to fault resolutions database 504. For example, user devices may provide resolution feedback indicating that a new fault resolution was successful in resolving an identified fault. A new fault resolution may be defined as a resolution not currently listed in fault resolutions database 504 as a potential resolution for the identified fault. In some embodiments, fault triage system 502 treats new fault resolutions as suggested resolutions. For example, fault triage system 502 may provide the suggested resolutions to subject matter experts (SMEs) for review. Based on feedback from the SMEs, fault triage system 502 may either add the new fault resolution to fault resolutions database 502 or discard the new fault resolution.

### User Interfaces

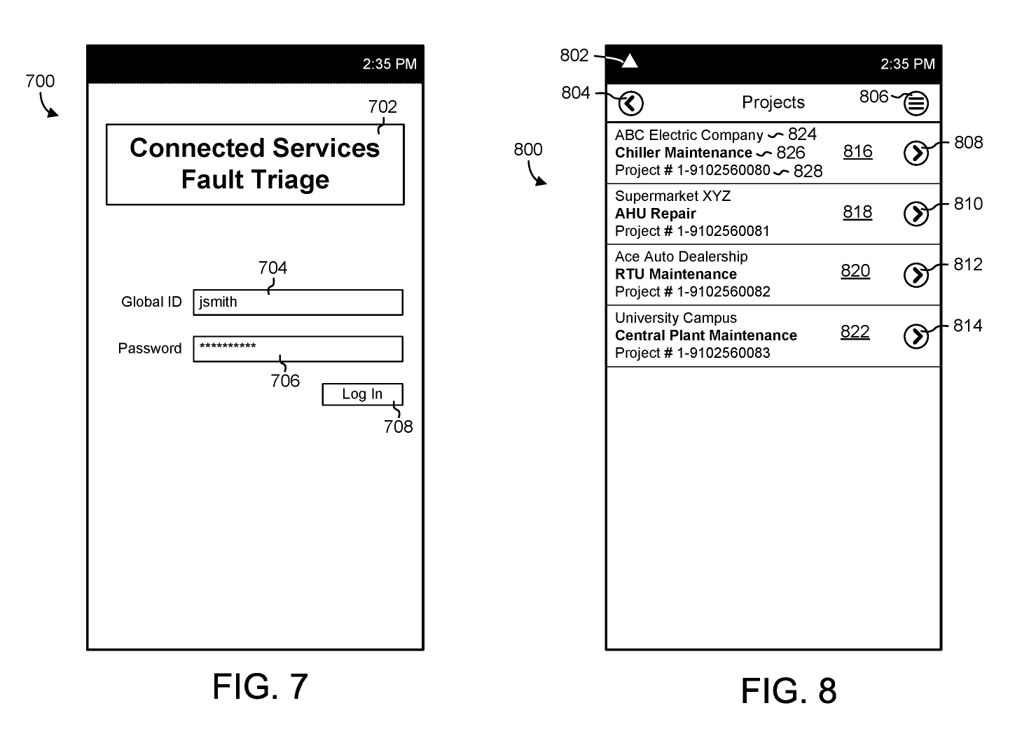

Referring now to FIGS. 7-15, several user interfaces 700-1500 which may be presented on user device 506 are shown, according to an exemplary embodiment. User interfaces 700-1500 may be generated by fault triage system 502 and/or by an application running on user device 506 based on the information received from fault triage system 502. For example, the application running on user device 506 may use the information from fault triage system 502 to present a list of projects, prioritized faults, suggested resolutions, and success rates via user device 506. A service technician can use this information to implement one or more of the suggested resolutions. In some embodiments, the application running on user device 506 causes user device 506 to prompt a user for resolution feedback via one or more of interfaces 700-1500. The resolution feedback may be provided to fault triage system 502 and used to update the success rates and/or potential resolutions stored in fault resolutions database 504, as previously described.

Referring particularly to FIG. 7, a login interface 700 is shown, according to an exemplary embodiment. Login interface 700 is shown to include a title 702, an ID field 704, and a password field 706. A service technician can enter his or her user ID and password into fields 704-706 and select login button 708 to login to fault triage system 502.

Referring now to FIG. 8, a project selection interface 800 is shown, according to an exemplary embodiment. Project selection interface 800 is shown to include a listing of projects 816, 818, 820, and 822. In some embodiments, projects 816-822 are retrieved from projects database 620. Projects 816-822 may be service contract-related items which are the responsibility of the service technician. In some embodiments, the list of projects 816-822 displayed in projects interface 800 is specific to the service technician. For example, fault triage system 502 may provide user device 506 with a list of projects that correspond to the user identified by the login credentials provided via login interface 700.

Each project displayed in project selection interface 800 may include a site name 824, a project name 826, and a project number 828. For example, project 816 is shown to include the site name “ABC Electric Company,” which may identify a particular customer site at which the project is to be performed. Project 816 is shown to include the project name “Chiller Maintenance,” which may identify the type or category of project to be performed (e.g., maintenance, installation, repair, replacement, etc.). In some embodiments, the project name also identifies a particular device or type of device (e.g., chiller, AHU, RTU, etc.) for which the project will be performed. Project 816 is shown to include the project number “1-9102560080,” which may be a unique ID assigned to the project.

In some embodiments, project selection interface 800 includes a proximity notification 802. Notification 802 may appear when the location of user device 506 is within a predetermined proximity threshold of one of the project locations shown in projects interface 800. Selecting proximity notification 802 may cause projects interface 800 to display a list of tools required for the associated project and/or other information relating to the project.

Project selection interface 800 is shown to include a back button 804 and an options button 806. Selecting back button 804 may cause user device 506 to return to login interface 700. In some embodiments, back button 804 may be omitted from project selection interface 800. Selecting options button 806 may cause a list of options to be displayed. Available options may include, for example, a help option, a logout option, contact information for field support (e.g., a phone number, a website, an email address, etc.), a search option, or other selectable options or information relating to projects 816-822.

Project selection interface 800 is shown to include a project selection button 808-814 for each of projects 816-822. Selecting one of project selection buttons 808-814 may cause user device 506 to navigate to user interface 900 for the corresponding project. For example, selecting button 808 may cause user interface 900 to display the details of project 816, selecting button 810 may cause user interface 900 to display the details of project 818, selecting button 812 may cause user interface 900 to display the details of project 820, and selecting button 814 may cause user interface 900 to display the details of project 822.

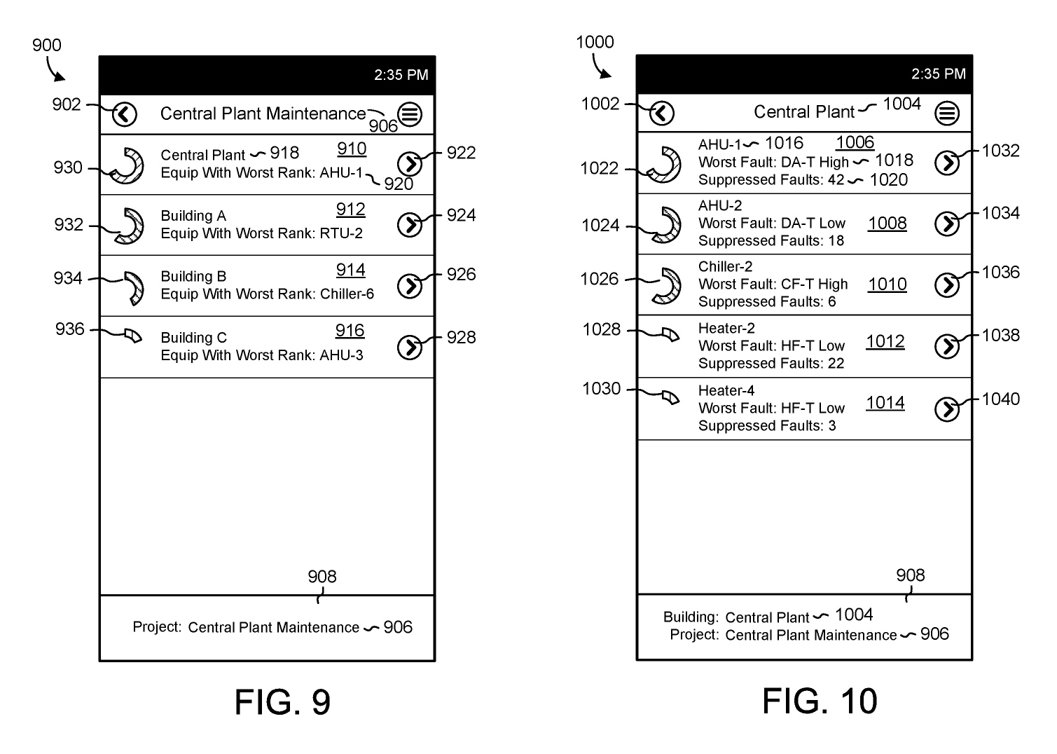

Referring now to FIG. 9, a building selection interface 900 is shown, according to an exemplary embodiment. Building selection interface 900 may be displayed in response to selecting one of projects 816-822 via project selection interface 800. Building selection interface 900 is shown to include several details of the selected project including, for example, the project name 906 and a selection sequence 908. Project name 906 may display the name of the project that was selected in interface 800. Selection sequence 908 may display a sequence of previous navigation selections that resulted in the current screen. In interface 900, selection sequence 908 is shown displaying only the project name because only a project has been selected. As a user navigates through the selection interface by selecting various items (e.g., a building, equipment, a fault, etc.), sequence 908 may be updated to display the sequence of selections, as shown in FIGS. 10-15. Building selection interface 900 may include a listing of one or more buildings 910-916 located at the customer site. Each building may include a building name 918 (e.g., Central Plant, Building A, Building B, Building C, etc.) and an indication 920 of the worst fault associated with the building. Indication 920 may identify the equipment with the highest ranking fault within the corresponding building. For example, indication 920 is shown identifying the equipment “AHU-1” as having the highest ranking fault within the “Central Plant” building 910.

In some embodiments, buildings 910-916 are ordered based on the ranks of the highest ranking fault within each building. The ranks of the highest ranking fault within each building may be determined by fault prioritizer 614 and shown by rank indicators 930-936. For example, rank indicator 930 indicates the rank of the highest ranking fault within building 910, rank indicator 932 indicates the rank of the highest ranking fault within building 912, rank indicator 934 indicates the rank of the highest ranking fault within building 914, rank indicator 936 indicates the rank of the highest ranking fault within building 916. Buildings 910-916 may be ordered in interface 900 such that the building with the highest ranking fault is shown first, followed by the building with the second highest ranking fault, and so on.

Rank indicators 930-936 may be graphical or numerical indicators having attributes based on the corresponding fault rankings. Rank indicators 930-936 are shown to include portions or fractions of a circular ring. The amount of the circular ring shown in each of rank indicators 930-936 may correspond to the rank of the corresponding fault. For example, a fault with the maximum possible ranking (e.g., 100/100) may be represented with a complete circular ring, whereas a fault with half the maximum possible ranking (e.g., 50/100) may be represented with half of a circular ring. In some embodiments, ranking indicators 930-936 have different colors based on the fault rankings. For example, fault rankings within a first range may be represented by rank indicators of a first color (e.g., red), fault rankings within a second range may be represented by rank indicators of a second color (e.g., orange), fault rankings within a third range may be represented by rank indicators of a third color (e.g., yellow), and so on. Any number of colors may be used to represent any number of different ranges of fault rankings.

Building selection interface 900 is shown to include a back button 902 and a building selection button 922-928 for each of buildings 910-916. Selecting back button 902 may cause user device 506 to return to project selection interface 800. Selecting one of building selection buttons 922-928 may cause user device 506 to navigate to user interface 1000 for the corresponding building. For example, selecting button 922 may cause user interface 1000 to display one or more items of faulty equipment within building 910, selecting button 924 may cause user interface 1000 to display one or more items of faulty equipment within building 912, selecting button 926 may cause user interface 1000 to display one or more items of faulty equipment within building 914, and selecting button 928 may cause user interface 1000 to display one or more items of faulty equipment within building 916.

Referring now to FIG. 10, an equipment selection interface 1000 is shown, according to an exemplary embodiment. Equipment selection interface 1000 may be displayed in response to selecting one of buttons 922-928 in building selection interface 900. Equipment selection interface 1000 is shown to include details of the selected building including, for example, a building name 1004 and the project name 906 as part of selection sequence 908.

Equipment selection interface 1000 is shown to include a list of equipment 1006-1014 with active faults within the selected building. Each item of equipment may include an equipment name 1016 (e.g., AHU-1, AHU-2, Chiller-2, Heater-2, Heater-4, etc.), an indication 1018 of the worst fault associated with the equipment, and an indication 1020 of the number of suppressed faults for the item of equipment. Worst fault indication 1018 may identify the fault with the highest fault ranking for each item of equipment 1006-1014, as determined by fault prioritizer 614. For example, worst fault indication 1018 is shown identifying the fault “DA-T High” as having the worst fault ranking of all the faults associated with the equipment “AHU-1.” Suppressed faults indication 1020 may identify the number of faults that were suppressed by fault suppressor 612 for each item of equipment 1006-1014.

In some embodiments, equipment 1016-1014 are ordered based on the ranks of the highest ranking fault for item of equipment. The ranks of the highest ranking fault for each item of equipment may be determined by fault prioritizer 614 and shown by rank indicators 1022-1030. For example, rank indicator 1022 indicates the rank of the highest ranking fault for AHU-1 1006, rank indicator 1024 indicates the rank of the highest ranking fault for AHU-2 1008, rank indicator 1026 indicates the rank of the highest ranking fault for Chiller-2 1010, rank indicator 1028 indicates the rank of the highest ranking fault for Heater-2 1012, and rank indicator 1030 indicates the rank of the highest ranking fault for Heater-4 1014. Rank indicators 1022-1030 may be graphical or numerical indicators having attributes based on the corresponding fault rankings. In some embodiments, rank indicators 1022-1030 are the same or similar to rank indicators 930-936, as previously described. Equipment 1006-1014 may be ordered in interface 1000 such that the equipment with the highest ranking fault is shown first, followed by the equipment with the second highest ranking fault, and so on.

Equipment selection interface 1000 is shown to include a back button 1002 and an equipment selection button 1032-1040 for each of equipment 1006-1014. Selecting back button 1002 may cause user device 506 to return to building selection interface 900. Selecting one of equipment selection buttons 1032-1040 may cause user device 506 to navigate to user interface 1100 for the corresponding item of equipment. For example, selecting button 1032 may cause user interface 1100 to display one or more faults detected in AHU-1 1006, selecting button 1034 may cause user interface 1100 to display one or more faults detected in AHU-2 1008, selecting button 1036 may cause user interface 1100 to display one or more faults detected in Chiller-2 1010, selecting button 1038 may cause user interface 1100 to display one or more faults detected in Heater-2 1012, and selecting button 1040 may cause user interface 1100 to display one or more faults detected in Heater-4 1014.

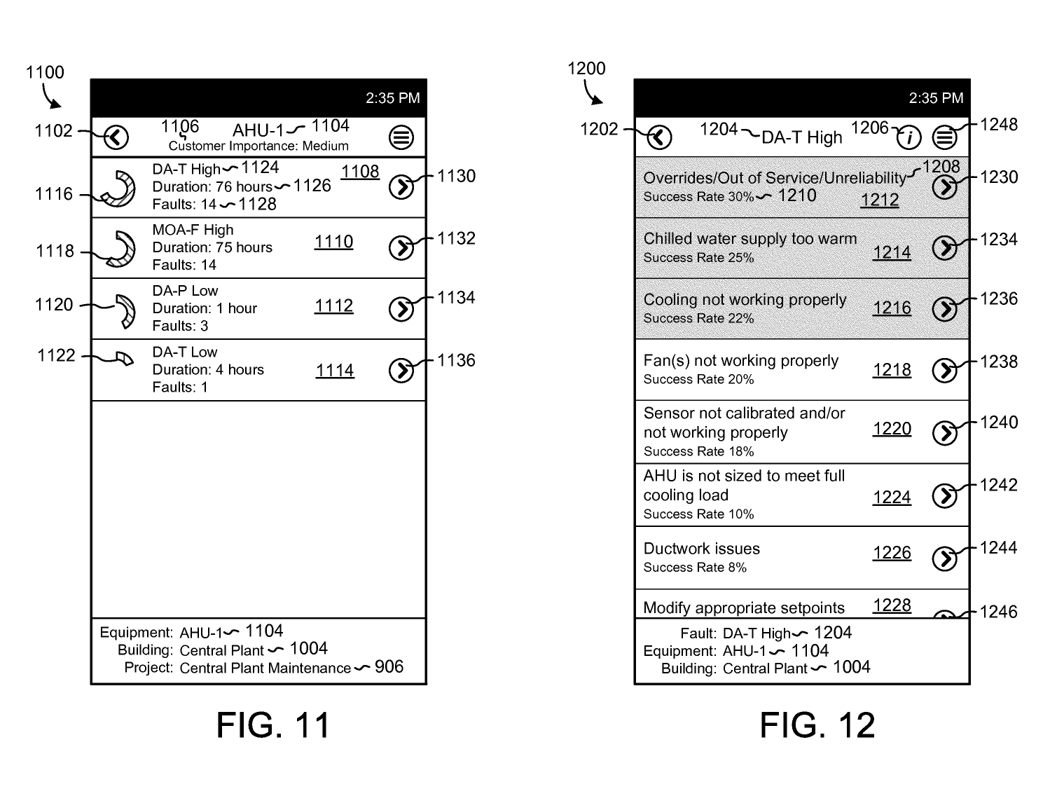

Referring now to FIG. 11, a fault selection interface 1100 is shown, according to an exemplary embodiment. Fault selection interface 1100 may be displayed in response to selecting one of buttons 1032-1040 in equipment selection interface 1000. Fault selection interface 1100 is shown to include details of the selected equipment including, for example, an equipment name 1104, the building name 1004, and the project name 906 as part of selection sequence 908. Fault selection interface 1100 may also indicate the customer importance 1106 of the selected item of equipment.

Fault selection interface 1100 is shown to include a list of faults 1108-1114 within the selected equipment. Each fault may include a fault name 1124 (e.g., DA-T High, MOA-F High, DA-P Low, DA-T, Low, etc.), a duration 1126 of the fault, and an indication 1128 of the number fault occurrences. Duration 1126 may indicate the overall fault duration, the average fault duration, or the individual fault duration, as determined by fault prioritizer 614. Fault occurrence indication 1128 may identify the number of identical faults and/or child faults grouped within each fault shown in interface 1100.

In some embodiments, faults 1108-1114 are ordered based on their respective fault rankings, as determined by fault prioritizer 614. The fault rankings are shown by rank indicators 1116-1122. For example, rank indicator 1116 indicates the rank of fault 1108, rank indicator 1118 indicates the rank of fault 1110, rank indicator 1120 indicates the rank of fault 1112, and rank indicator 1122 indicates the rank of fault 1114. Rank indicators 1116-1122 may be graphical or numerical indicators having attributes based on the corresponding fault rankings. In some embodiments, rank indicators 1116-1122 are the same or similar to rank indicators 930-936 and/or rank indicators 1022-1030, as previously described. Faults 1108-1114 may be ordered in interface 1100 such that the highest ranking fault is shown first, followed by the second highest ranking fault, and so on.

Fault selection interface 1100 is shown to include a back button 1102 and a fault selection button 1130-1136 for each of faults 1108-1114. Selecting back button 1102 may cause user device 506 to return to equipment selection interface 1000. Selecting one of fault selection buttons 1130-1136 may cause user device 506 to navigate to user interface 1200 for the fault. For example, selecting button 1130 may cause user interface 1200 to display one or more potential resolutions for fault 1108, selecting button 1132 may cause user interface 1200 to display one or more potential resolutions for fault 1110, selecting button 1134 may cause user interface 1200 to display one or more potential resolutions for fault 1112, and selecting button 1136 may cause user interface 1200 to display one or more potential resolutions for fault 1114.

Referring now to FIG. 12, a fault diagnosis interface 1200 is shown, according to an exemplary embodiment. Fault diagnosis interface 1200 may be displayed in response to selecting one of buttons 1130-1136 in fault selection interface 1100. Fault diagnosis interface 1200 is shown to include details of the selected fault including, for example, a fault name 1204, the equipment name 1104, and the building name 1004. Fault diagnosis interface 1200 may also include an information button 1206. Selecting information button 1206 may cause detailed information regarding the selected fault to be displayed. For example, selecting information button 1206 may cause the display of an explanation of the fault which can be understood by an end user unfamiliar with the circumstances under which the building equipment would produce a fault.

Fault diagnosis interface 1200 is shown to include a list of potential diagnoses 1212-1228 (i.e., causes) for the selected fault. Each potential diagnosis 1212-1228 may include a name 1208 of the diagnosis and a success rate 1210 of the diagnosis. Diagnosis name 1208 may describe the fault diagnosis and/or a root cause of the fault diagnosis (e.g., overrides/out of service/unreliability, chilled water supply too warm, cooling not working properly, etc.). Success rate 1210 may be the success rate stored in fault resolutions database 504 for the corresponding fault-resolution pair. For example, the success rate of 22% shown for diagnoses 1216 indicates the relative probability that the correct diagnosis (i.e., the actual cause) of the fault “DA-T High” is “Cooling not working properly.” Success rates 1210 may be retrieved from fault resolutions database 504 and/or generated by success rate generator 618 as previously described.

In some embodiments, diagnoses 1212-1228 are ordered based their corresponding success rates 1210. For example, the diagnosis with the highest success rate may be ordered first, followed by the diagnosis with the second highest success rate, etc. Advantageously, this allows an end user to readily identify the most likely diagnosis for the selected fault. A service technician can use diagnoses 1212-1228 to investigate potential causes of selected fault and implement suggested resolutions. The service technician can work through each of diagnoses 1212-1228 sequentially until the cause of the fault is identified.

In some embodiments, fault diagnosis interface 1200 is configured to highlight or mark one or more of diagnoses 1212-1228 based on whether the issue was found in the customer system. For example, after investigating a potential diagnosis, the service technician may provide feedback regarding whether the issue was found. If the issue was not found, interface 1200 may cause the corresponding diagnosis to be shaded or highlighted indicating that the diagnosis was investigated and determined to not be the cause of the fault. In FIG. 12, diagnoses 1212-1216 are shown shaded in gray indicating that diagnoses 1212-1216 were determined to not be the cause of the fault.

Fault diagnosis interface 1200 is shown to include a back button 1202, an options button 1248, and a diagnosis selection button 1230-1246 for each of diagnoses 1212-1228. Selecting back button 1202 may cause user device 506 to return to fault selection interface 1100. Selecting options button 1248 may display a list of options for the selected fault (e.g., enable or disable the selected fault, suggest an alternative diagnosis, etc.). Selecting one of diagnosis selection buttons 1230-1246 may cause user device 506 to navigate to user interface 1500 for the selected diagnosis. For example, selecting button 1230 may cause user interface 1500 to display one or more potential resolutions for diagnosis 1212, selecting button 1234 may cause user interface 1500 to display one or more potential resolutions for diagnosis 1214, selecting button 1236 may cause user interface 1500 to display one or more potential resolutions for diagnosis 1216, etc.

Referring now to FIG. 13, a disable fault interface 1300 is shown, according to an exemplary embodiment. Disable fault interface 1300 may be displayed in response to selecting a “disable fault” option at the bottom of the list of diagnoses and success rates in interface 1200. Disable fault interface 1300 is shown to include a disable fault window 1302. Disable fault window 1302 may include a reason field 1304, a cancel button 1306, and a submit button 1308. Reason field 1304 may be a text entry field which allows a user to enter a reason why the fault is being disabled. Cancel button 1306 may be selected to cancel disabling the fault. Submit button 1308 may be selected to confirm disabling the fault. After selecting submit button 1308, the fault may be disabled (e.g., hidden, removed, marked as disabled, etc.) in fault selection interface 1100. An fault selection interface with a disabled fault is shown in FIG. 14.

Referring now to FIG. 14, another fault selection interface 1400 is shown, according to an exemplary embodiment. Fault selection interface 1400 may be the same or similar to fault selection interface 1100. However, in fault selection interface 1400, fault 1108 is marked as disabled. Disabled faults may be shown under a disabled faults heading 1410 and may be shown or hidden by selecting button 1412. Each disabled fault may include the fault name 1124, a timestamp 1402 indicating when the fault was disabled, and a user ID 1404 of the user that disabled the fault. Disabled faults can be re-enabled by selecting button 1414, which may cause interface 1300 to be displayed.

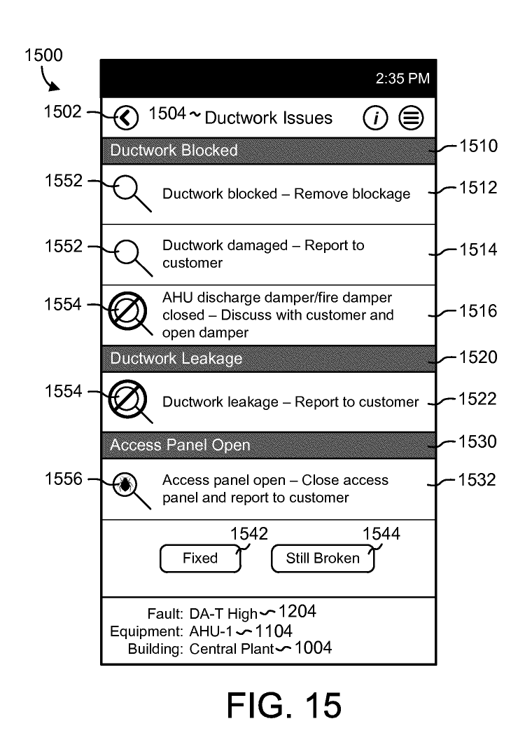

Referring now to FIG. 15, a fault resolution interface 1500 is shown, according to an exemplary embodiment. Fault resolution interface 1500 may be displayed in response to selecting one of buttons 1230-1246 in fault diagnosis interface 1200. Fault resolution interface 1500 is shown to include details of the selected fault diagnosis including, for example, the name of the selected fault diagnosis 1504, the fault name 1204, the equipment name 1104, and the building name 1004.

In the exemplary embodiment shown in FIG. 15, details of the diagnosis “Ductwork Issues” are shown. The information shown in interface 1500 indicates that the fault “DA-T High” with the equipment “AHU-1” in the “Central Plant” building may potentially be caused by ductwork issues. In some embodiments, fault resolution interface 1500 identifies multiple sub-diagnoses within the selected fault diagnoses. For example, the diagnosis “Ductwork Issues” is shown to include sub-diagnoses “Ductwork Blocked” 1510, “Ductwork Leakage” 1520, and “Access Panel Open” 1530. Each of the sub-diagnoses may be identified by a separate heading within fault resolution interface 1500.

Fault resolution interface 1500 may include one or more suggested resolutions 1512-1516, 1522, and 1532 for the selected fault diagnosis and/or sub-diagnoses. The suggested resolutions may identify particular steps or actions that can be performed to resolve the fault. For example, fault resolution interface 1500 indicates that the “Ductwork Blocked” sub-diagnosis 1510 can be resolved by removing the blockage (resolution 1512), inspecting the ductwork for damage (resolution 1514), and/or opening an emergency fire damper (resolution 1514). Similar resolutions 1522 and 1532 are provided for the “Ductwork Leakage” sub-diagnosis 1520 and the “Access Panel Open” sub-diagnosis 1530. A service technician can perform the steps or actions identified in fault resolution interface 1500 to implement one or more of the suggested resolutions. If the corresponding diagnosis is true (i.e., the diagnosis accurately identifies the cause of the fault), the suggested resolutions may be effective in resolving the fault.

In some embodiments, fault triage system 502 generates the list of suggested resolutions based on the building data received from BMS 400. Advantageously, this allows the service technician to readily identify the suggested resolutions that are most likely to resolve the fault based on the actual state of the customer system, as indicated by the building data. This also allows the service technician to rule out any potential resolutions that are not likely to be successful if the corresponding issue is not detected in the customer system, based on the building data.

An end user (e.g., the service technician, a customer, etc.) may investigate each of the suggested resolutions to determine whether any of the issues corresponding to the suggested resolutions are actually present in the customer system. The end user may annotate each suggested resolution with an indication of whether the corresponding issue was found. Such annotations are shown in FIG. 15 as a magnifying glass icon 1552, a negated magnifying glass icon 1554, and a magnifying glass icon with a bug 1556.

Fault triage system 502 may initially annotate each suggested resolution with a first annotation (e.g., the magnifying glass icon 1552) indicating that the resolution has not yet been inspected. The first annotation may indicate that the corresponding diagnosis may be true but is not conclusively confirmed to be true or false. The presence of the first annotation may indicate that the end user should investigate the issue to determine whether the diagnosis is true. For example, the end user may investigate the “Ductwork Blocked” diagnosis by inspecting the ductwork for blockage and/or damage. The end user may change the annotation based on whether the issue was found in the customer system (e.g., by tapping or clicking on the annotation).

The end user may annotate a suggested resolution with a second annotation (e.g., the negated magnifying glass icon 1554) if the corresponding diagnosis is confirmed to be false as a result of the user inspection. The presence of the second annotation may indicate that the suggested resolution did not or will not resolve the fault since the issue it addresses is not present in the customer system. For example, interface 1500 is shown with suggested resolutions 1516 and 1522 annotated with the negated magnifying glass icon 1554. This indicates that the corresponding diagnoses “AHU discharge damper/fire damper closed” and “ductwork leakage” have been confirmed to be false based on the user inspection. Measurements from a damper position sensor, flowrate sensor, pressure sensor, and/or other ductwork sensors may be used to confirm that the damper is in fact open and that no ductwork leakage is occurring. If all of the suggested resolutions are inspected and none of the corresponding diagnoses are confirmed to be true, the end user may annotate all of the suggested resolutions with the second annotation and click the “Still Broken” button 1544. Fault triage system 502 may use this feedback to adjust (e.g., decrease) the stored success rates for the ineffective resolutions.

The end user may annotate a suggested resolution with a third annotation (e.g., the magnifying glass with the bug 1556) if the corresponding diagnosis is confirmed to be true as a result of the user inspection. The presence of the third annotation may indicate that the suggested resolution may be successful or was successful in resolving the fault since the issue it addresses is confirmed to be present in the customer system. For example, interface 1500 is shown with suggested resolution 1532 annotated with the magnifying glass with the bug 1556. This indicates that the corresponding diagnosis “Access Panel Open” has been confirmed to be true based on the user inspection. Measurements from an access panel position sensor may be used to confirm that the access panel is in fact open. If a suggested resolution is implemented and found to resolve the fault, the end user may annotate the resolution with the third annotation and click the “Fixed” button 1542. Fault triage system 502 may use this feedback to adjust (e.g., increase) the stored success rate for the successful resolution.

Fault triage system 502 may use the building data to automatically determine whether a potential diagnosis is confirmed to be true, confirmed to be false, or cannot be confirmed based on the building data. Fault triage system 502 may generate the list of suggested resolutions based on a result of the determination. Advantageously, this allows the service technician to selectively investigate only a subset of the potential diagnoses and implement a subset of the suggested resolutions, thereby saving time and allowing the service technician to readily identify the correct diagnosis for the fault.

Still referring to FIG. 15, fault resolution interface 1500 is shown to include a fixed button 1542 and a still broken button 1544. After implementing a suggested resolution, the service technician can select either fixed button 1542 or still broken button 1544 to indicate whether the suggested resolution was successful in resolving the fault. The resolution feedback may be provided to fault triage system 502 and used by fault triage system 502 to update the success rates stored in fault resolutions database, as described with reference to FIGS. 5-6.

### Process for Resolving Faults in a Building System

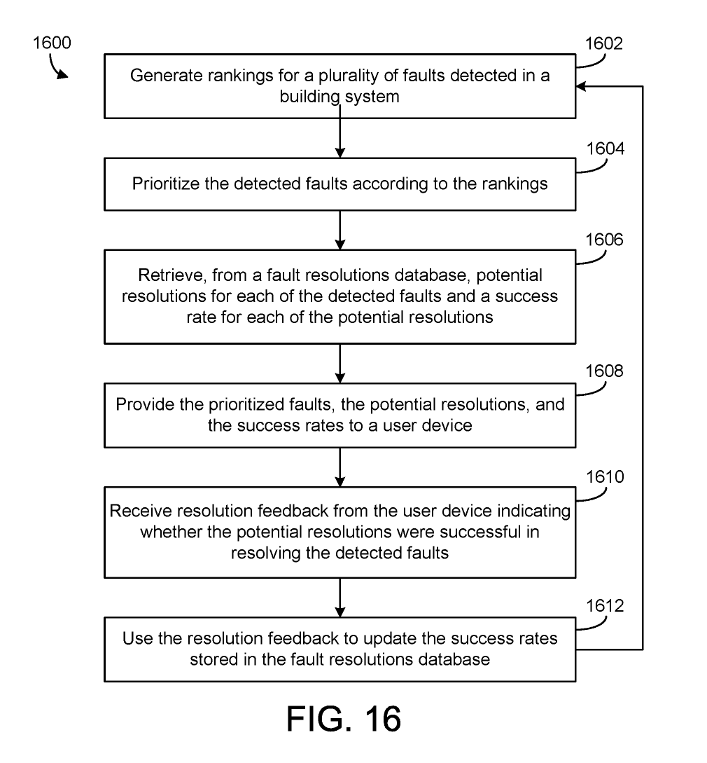

Referring now to FIG. 16, a flowchart of a process 1600 for resolving faults in a building system is shown, according to an exemplary embodiment. Process 1600 may be performed by one or more components of system 500 and/or fault triage system 502, as described with reference to FIGS. 5-6. Process 1600 may be used in conjunction with any of systems 100-400 to resolve faults in one or more components or subsystems thereof. For example, process 1600 may be used to provide fault detection, diagnostics, and resolution services for HVAC system 100, waterside system 200, airside system 300, and/or BMS 400, including any of building subsystems 428 (e.g., HVAC subsystem 440, fire safety subsystem 430, lighting subsystem 442, security subsystem 438, etc.) as described with reference to FIGS. 1-4.

Process 1600 is shown to include generating rankings for a plurality of faults detected in a building system (step 1602) and prioritizing the detected faults according to the rankings (step 1604). In some embodiments, steps 1602 and 1604 are performed by fault prioritizer 614, as described with reference to FIG. 6. Step 1602 may include generating and assigning rankings to various faults based on predetermined ranking criteria. In some embodiments, the ranking criteria include a plurality of weighted factors that describe the fault and/or the effects of the fault. For example, the factors may include fault severity, customer importance, overall fault duration, average fault duration, the number of occurrences of the fault, the number of child faults estimated to be caused by the fault, the monetary value of the fault, the type of system or device associated with the fault, etc. Step 1602 may include determining (e.g., generating, assigning, calculating, etc.) a value for each of these factors based on the building data.

Step 1602 may include assigning a weight to each of the factors and using the weighted factors to calculate a ranking or score for each of the faults. The weights may indicate the importance of the factors relative to each other. The weights assigned to each of the factors may be determined by subject matter experts, set by a user, or automatically determined (e.g., by fault prioritizer 614). In some embodiments, step 1602 includes calculating an overall ranking for each fault by multiplying the value of each factor by the corresponding weight and summing the resultant products.

Step 1604 may include prioritizing the faults based on their respective rankings. In some embodiments, step 1604 includes prioritizing faults with a higher ranking over faults with a lower ranking. Step 1604 may include generating an ordered list of the faults in which the order is based on the ranking or priority of each fault. Higher priority faults may be listed before lower priority faults in the ordered list. Step 1604 may include providing the prioritized faults along with their rankings to a user device. The prioritized faults may include the detected faults, the ranking or priority assigned to each fault, and/or other attributes of the fault (e.g., fault duration, number of suppressed faults, etc.).

Still referring to FIG. 16, process 1600 is shown to include retrieving, from a fault resolutions database, potential resolutions for each of the detected faults and a success rate for each of the potential resolutions (step 1606). The fault resolutions database may be the same or similar to fault resolutions database 504. For example, the fault resolutions database may store one or more fault diagnoses for each fault that may occur. The fault resolutions database may also store one or more suggested actions that can be performed to resolve each fault. When a fault is detected, step 1606 may be performed to identify the potential fault diagnoses and the corresponding corrective actions.

In some embodiments, step 1606 includes using the potential resolutions to generate a set of suggested resolutions. The suggested resolutions may include some or all of the potential resolutions for a particular fault, as indicated by the information stored in the fault resolutions database. In some embodiments, the suggested resolutions include a subset of the potential resolutions retrieved from the fault resolutions database. For example, step 1606 may include modifying the set of potential resolutions for a particular fault based on the building data received from the building system (e.g., by removing potential resolutions that are not applicable based on the building data).

In some embodiments, step 1606 includes using the building data to automatically determine whether each of the potential resolutions from the fault resolutions database is applicable to the fault at issue. If a particular diagnosis is confirmed or suggested by the building data, step 1606 may include causing the corresponding potential resolution to be highlighted or marked as a potential issue when presented via the user device. Similarly, if the diagnosis is confirmed or suggested to be incorrect by the end user, step 1606 may include marking the corresponding potential resolution as not applicable or removing the potential resolution from the list of suggested resolutions provided to the user device. In this way, the list of suggested resolutions can be customized to the fault at issue based on the building data.

As previously described, the fault resolutions database may store a success rate for each potential resolution. The success rate may indicate the relative likelihood that the potential resolution will resolve a particular fault. Each success rate may be specific to a particular resolution as that resolution pertains to a particular fault or combination of faults. In other words, each success rate may apply to a particular fault-resolution pair.

In some embodiments, step 1606 includes modifying the success rates retrieved from the fault resolutions database based on the feedback from the end user. For example, if the end user suggests a particular diagnosis for the detected fault, step 1606 may include increasing the success rate of the corrective actions corresponding to the suggested diagnosis. However, if the end user confirms or suggests that the diagnosis does not apply to the fault at issue, step 1606 may include decreasing the success rate of the corrective actions corresponding to the diagnosis. In some embodiments, step 1606 includes modifying the success rates based on the co-occurrence of multiple faults. For example, if multiple faults are detected which could potentially be caused by the same underlying root cause, step 1606 may include increasing the success rate of the corrective actions corresponding to the shared root cause.

Still referring to FIG. 16, process 1600 is shown to include providing the prioritized faults, the potential resolutions, and the success rates to a user device (step 1608). In some embodiments, the user device is a portable electronic device which may be used by a service technician at a customer site. For example, the service technician may travel to the customer site and run an application installed on the user device to retrieve prioritized faults, the potential resolutions, and the success rates. The user device may generate and display an ordered list of prioritized faults along with their suggested resolutions and success rates. The service technician can use the information provided in step 1608 to diagnose the detected faults and implement one or more of the suggested resolutions.

Still referring to FIG. 16, process 1600 is shown to include receiving resolution feedback from the user device indicating whether the potential resolutions were successful in resolving the detected faults (step 1610) and using the resolution feedback to update the success rates stored in the fault resolutions database (step 1612). After implementing a suggested resolution, the user device may prompt the service technician to specify whether the suggested resolution was successful in resolving the fault. In step 1610, feedback is received from the user device indicating whether the suggested resolution was successful in resolving the fault. In step 1612, the resolution feedback is used to update the success rate of the suggested resolution with respect to the fault at issue. For example, step 1612 may include increasing the success rate for a suggested resolution with respect the fault at issue if the resolution feedback indicates that the suggested resolution was successful in resolving the fault. Conversely, step 1612 may include decreasing the success rate for the suggested resolution if the resolution feedback indicates that the suggested resolution was not successful in resolving the fault.

In some embodiments, steps 1610-1612 include using crowdsourced resolution feedback from a plurality of user devices to update the success rates stored in the fault resolutions database. Crowdsourced resolution feedback may be received from multiple different user devices based on whether the suggested resolutions were successful to resolve faults in multiple different customer systems. For example, step 1610 may include receiving crowdsourced resolution feedback from user devices located in different geographic regions (e.g., different cities, different states, different countries, etc.). Step 1612 may include using the crowdsourced resolution feedback to update the success rates stored in a centralized fault resolution database. This allows process 1600 modify the stored success rates to more accurately reflect actual field conditions and allows users to share information with one another. When the same fault is detected again, process 1600 can be repeated to identify and prioritize resolutions that are most likely to be successful based on the crowdsourced feedback.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A fault resolution system comprising:
a fault triage system that generates rankings for a plurality of faults detected in a building system and prioritizes the detected faults according to the rankings;
a fault resolutions database that stores one or more potential resolutions for each of the detected faults and a success rate for each of the potential resolutions; and
a user device that receives the prioritized faults, the potential resolutions, and the success rates from the fault triage system and provides resolution feedback to the fault triage system indicating whether the potential resolutions were successful in resolving the detected faults;
wherein the fault triage system uses the resolution feedback to update the success rates stored in the fault resolutions database.

2. The system of claim 1, wherein one or more of the potential resolutions are implemented in the building system and the resolution feedback is based on an effect of implementing the potential resolutions in the building system.

3. The system of claim 1, wherein each of the success rates stored in the fault resolutions database is specific to a fault-resolution pair comprising a fault and a resolution, the success rate indicating a likelihood that the resolution will be successful in resolving the fault.

4. The system of claim 1, wherein the fault triage system uses building data from the building system to automatically determine which of the potential resolutions are applicable to the prioritized faults.

5. The system of claim 4, wherein the fault triage system uses the feedback from the user device to confirm that one or more diagnoses for the prioritized faults are true and increases the success rates of the potential resolutions provided to the user device in response to confirming that the diagnoses are true.

6. The system of claim 4, wherein the fault triage system uses the feedback from the user device to confirm that one or more diagnoses for the prioritized faults are false and decreases the success rates of the potential resolutions provided to the user device in response to confirming that the diagnoses are false.

7. The system of claim 1, wherein:
the fault triage system provides the rankings to the user device along with the prioritized faults; and
the user device uses the rankings to generate and display an ordered list of the prioritized faults according to the rankings.

8. The system of claim 1, wherein the fault triage system uses building data from the building system to automatically detect the plurality of faults in the building system.

9. A fault triage system comprising:
a fault prioritizer that generates rankings for a plurality of faults detected in a building system and prioritizes the detected faults according to the rankings;
a fault resolutions database that stores one or more potential resolutions for each of the detected faults and a success rate for each of the potential resolutions;
a communications interface that provides the prioritized faults, the potential resolutions, and the success rates to a user device and receives resolution feedback from the user device indicating whether the potential resolutions were successful in resolving the detected faults; and
a success rate updater that receives the resolution feedback from the communications interface and uses the resolution feedback to update the success rates stored in the fault resolutions database.

10. The system of claim 9, wherein one or more of the potential resolutions are implemented in the building system and the resolution feedback is based on an effect of implementing the potential resolutions in the building system.

11. The system of claim 9, wherein each of the success rates stored in the fault resolutions database is specific to a fault-resolution pair comprising a fault and a resolution, the success rate indicating a likelihood that the resolution will be successful in resolving the fault.

12. The system of claim 9, further comprising a resolution suggestor that uses building data from the building system to automatically determine which of the potential resolutions are applicable to the prioritized faults.

13. The system of claim 12, wherein the resolution suggestor uses the building data to confirm that one or more diagnoses for the prioritized faults are true and annotates the potential resolutions provided to the user device to indicate that the diagnoses are true.

14. The system of claim 12, wherein the resolution suggestor uses the building data to confirm that one or more diagnoses for the prioritized faults are false and annotates the potential resolutions provided to the user device to indicate that the diagnoses are false.

15. The system of claim 9, wherein:
the fault triage system provides the rankings to the user device along with the prioritized faults; and
the user device uses the rankings to generate and display an ordered list of the prioritized faults according to the rankings.

16. The system of claim 9, further comprising a fault detector that uses building data from the building system to automatically detect the plurality of faults in the building system.

17. A method for resolving faults in a building system, the method comprising:
generating rankings for a plurality of faults detected in a building system;
prioritizing the detected faults according to the rankings;
retrieving, from a fault resolutions database, one or more potential resolutions for each of the detected faults and a success rate for each of the potential resolutions;
providing the prioritized faults, the potential resolutions, and the success rates to a user device;
receiving resolution feedback from the user device indicating whether the potential resolutions were successful in resolving the detected faults; and
using the resolution feedback to update the success rates stored in the fault resolutions database.

18. The method of claim 17, further comprising implementing one or more of the potential resolutions in the building system; and
generating the resolution feedback based on an effect of implementing the potential resolutions in the building system.

19. The method of claim 17, further comprising using building data from the building system to automatically determine which of the potential resolutions are applicable to the prioritized faults.

20. The method of claim 17, further comprising:
using the resolution feedback from the user device to confirm that one or more diagnoses for the prioritized faults are true or false; and
annotating the potential resolutions provided to the user device to indicate that the diagnoses are true or false.
